(19) United States
(12) Patent Application Publication
(10) Pub. No.: US 2014/0066094 A1
(43) Pub. Date: Mar. 6, 2014

(54) OBTAINING AND USNG COMPOSITE MEASUREMENTS FOR POSITIONING

(71) Applicant: TELEFONAKTIEBOLAGET L M ERICSSON (PUBL), Stockholm (SE)

(72) Inventors: Iana Siomina, Solna (SE); Yang Zhang, Shanghai (CN)

(73) Assignee: TELEFONAKTIEBOLAGET L M ERICSSON (PUBL), Stockholm (SE)

(21) Appl. No.: 13/882,849

(22) PCT Filed: Mar. 25, 2013
(86) PCT No.: PCT/SE2013/050334

§ 371 Date: May 1, 2013

Related U.S. Application Data
(60) Provisional application No. 61/678,462, filed on Aug. 1, 2012.

(51) Int. Cl. H04W 4/02

(52) U.S. Cl. CPC H04W 4/025
USPC 455/456.2; 455/456.5; 455/561

(57) ABSTRACT

A composite measurement may be used to determine a position of a target wireless device. The composite measurement may include a result of at least two measurement components. The two measurement components may be measurements performed on physical signal and/or channels transmitted from a same transmitting node and measured by a measuring node. Each measurement component includes one or more measurement configurations, where each configuration is of a resource, signal, transmitter, and receiver configuration types. The two measurement components have configurations of at least one common configuration type in which the configurations of the common type are different for the two measurement components.

### TECHNICAL FIELD

The technical field of the present disclosure generally relates to wireless communications networks and in particular to networks using positioning based on radio signal measurements.

### BACKGROUND

The possibility to determine the position of a mobile device has enabled application developers and wireless network operators to provide location based and location aware services. Examples of such services include guiding systems, shopping assistance, friend finder, presence services, community and communication services and other information services giving the mobile user information about their surroundings.

In addition to the commercial services, governments in several countries have put requirements on the network operators to be able to determine the position of an emergency call. For instance, governmental requirements in the USA (FCC E911) specify that it must be possible to determine the position of a certain percentage of all emergency calls. The requirements do not differentiate between indoor and outdoor environment.

In many environments, the position can be accurately estimated by using positioning methods based on Global Positioning System (GPS). However, GPS-based positioning may often have unsatisfactory performance e.g., in urban and/or indoor environments. Complementary positioning methods could thus be provided by a wireless network. In addition to UE-based GNSS (including GPS), the following methods are available in the LTE standard for both the control plane and the user plane:
Cell ID (CID);
E-CID, including network-based AoA;
A-GNSS (including A-GPS);
Observed Time Difference of Arrival (OTDOA);
UL Time Difference of Arrival (UTDOA)—being currently standardized.

TDOA-/TOA-Based Methods (e.g., OTDOA, UTDOA or GNSS/A-GNSS):

A typical format of the positioning result is an ellipsoid point with uncertainty circle/ellipse/ellipsoid which is the result of intersection of multiple hyperbolas/hyperbolic arcs (e.g., OTDOA) or circles/arcs (e.g., UTDOA, GNSS, or A-GNSS).

Hybrid Methods:

Since the hybrid technique involves a mix of any of the methods above, the position result can be any shape, but in many cases it is likely to be a polygon.

Cellular positioning methods rely on knowledge of anchor nodes' locations, e.g., eNodeB or beacon device locations for OTDOA, LMU antenna locations for UTDOA, eNodeB locations for E-CID. The anchor nodes' location may also be used to enhance AECID, hybrid positioning, etc.

### Positioning Protocols and Architectures

The three key network elements in an LTE positioning architecture are the LCS (Location Services) Client, the LCS target and the LCS Server. The LCS Server is a physical or logical entity managing positioning for a LCS target device by collecting measurements and other location information, assisting the terminal in measurements when necessary, and estimating the LCS target location. A LCS Client is a software and/or hardware entity that interacts with a LCS Server for the purpose of obtaining location information for one or more LCS targets, i.e., the entities being positioned. LCS Clients may reside in a network node, external node, PSAP, UE, radio base station, etc., and they may also reside in the LCS targets themselves. An LCS Client (e.g., an external LCS Client) sends a request to LCS Server (e.g., positioning node) to obtain location information, and LCS Server processes and serves the received requests and sends the positioning result and optionally a velocity estimate to the LCS Client.

Position calculation can be conducted, for example, by a positioning server (e.g., E-SMLC or SLP in LTE) or UE. The latter corresponds to the UE-based positioning mode, whilst the former may be network-based positioning (calculation in a network node based on measurements collected from network nodes such as LMUs (Location Measurement Unit) or eNodeBs), UE-assisted positioning (calculation is in a positioning network node based on measurements received from UE), LMU-assisted (calculation is in a positioning network node based on measurements received from LMUs), etc.

FIG. 1a illustrates the UTDOA architecture being currently discussed in 3GPP. Although UL measurements may in principle be performed by any radio network node (e.g., eNodeB), UL positioning architecture may include specific UL measurement units (e.g., LMUs) which e.g., may be logical and/or physical nodes, may be integrated with radio base stations or sharing some of the software or hardware equipment with radio base stations or may be completely standalone nodes with own equipment (including antennas). The architecture is not finalized yet, but there may be communication protocols between LMU and positioning node, and there may be some enhancements for LPPa or similar protocols to support UL positioning.

A new interface, SLm, between the E-SMLC and LMU is being standardized for UL positioning. The interface is terminated between a positioning server (E-SMLC) and LMU. It is used to transport SLmAP protocol (new protocol being specified for UL positioning) messages over the E-SMLC-to-LMU interface. Several LMU deployment options are possible. For example, an LMU may be a standalone physical node, it may be integrated into the eNodeB or it may be sharing at least some equipment such as antennas with the eNodeB—these three options are illustrated in the FIG. 1a.

LPPa (LPP annex) is a protocol between eNodeB and LCS Server specified only for control plane positioning procedures, although it still can assist user plane positioning by querying eNodeBs for information and eNodeB measurements. LPPa may be used for DL positioning and UL positioning.

In LTE, UTDOA measurements, UL RTOA, are performed on SRSs (Sounding Reference Signal). To detect an SRS signal, LMU needs a number of SRS parameters to generate the SRS sequence which is to be correlated to received signals. The SRS parameters used for generating the SRS sequence and determining when SRS transmissions occur may be provided in the assistance data transmitted by positioning node to LMU; these assistance data would be provided via SLmAP. However, these parameters may generally be not known to the positioning node, which needs then to obtain this information from eNodeB configuring the SRS to be transmitted by the UE and measured by LMU; this information would have to be provided in LPPa or similar protocol.

For DL positioning, LPP (LTE positioning protocol) has been standardized in LTE. LPP may be used over control plane or user plane connection (e.g., SUPL). LPP may also include elements-extensions such as LPPe (LPP extensions). FIG. 1b illustrates a DL positioning architecture.

### SUMMARY

A non-limiting aspect of the disclosed subject matter is directed to a method performed at a node to determine a position of a target wireless device. The node may be a wireless device (including the target device itself), or any of the network nodes. The method may include obtaining a composite measurement related to the target wireless device in which the composite measurement may be based on at least first and second measurement components. The first measurement component may include measurements performed on one or more first physical signals and/or channels transmitted from a transmitting node and measured by a measuring node. The first measurement component may be associated with one or more first measurement configurations specifying configurations related to the first signals. The second measurement component may include measurements performed on one or more second physical signals and/or channels transmitted from the same transmitting node and measured by the same measuring node. The second measurement component may be associated with one or more second measurement configurations specifying configurations related to the second signals. Preferably, the first and second measurement configurations, as a whole, are different. The method may also include determining the position of the target wireless device based at least on the composite measurement.

Another non-limiting aspect of the disclosed subject matter is directed to a computer readable medium which includes therein programming instructions executable by a computing device of a node to perform the method of the node as described above.

Another non-limiting aspect of the disclosed subject matter is directed to a node structured to determine a position of a target wireless device. The node may be a wireless device (including the target device itself), or any of the network nodes. The node may comprise a measurement manager and a positioning data manager. The measurement manager may be structured to obtain a composite measurement related to the target wireless device. The positioning data manager may be structured to determine the position of the target wireless device based at least on the composite measurement.

Another non-limiting aspect of the disclosed subject matter is directed to a method performed at a radio node to assist in positioning a target wireless device. The radio node may be a wireless device (including the target device itself), or any of the radio network nodes. The method may include receiving a positioning information request from a requesting node, in which the request may be related to positioning of the target wireless device. The method may also include obtaining one or more first measurement configurations and one or more second measurement configurations based on the positioning information request. The first measurement configurations may specify configurations related to one or more first signals transmitted from a transmitting node, and the second measurement configurations may specify configurations related to one or more second signals one transmitted from the same transmitting node. The method may further include measuring the first signals and/or channels and the second signals and/or channels corresponding to the first and second measurement configurations. The method may yet further include obtaining a positioning information response based on measurement results. The positioning information response may comprise any combination of a first measurement component, a second measurement component, a composite measurement, and a positioning result. The first measurement component may include measurements performed on the first signals and/or channels transmitted from the transmitting node and measured by the radio node, in which the first measurement component is associated with the first measurement configurations. The second measurement component may include measurements performed on one or more second signals and/or channels transmitted from the transmitting node and measured by the radio node, in which the second measurement component is associated with the second measurement configurations. Preferably, the first and second measurement configurations, as a whole, are different. The composite measurement may be based on at least the first and second measurement components. The positioning result may indicate positioning of the target wireless device. The method may additionally include sending the positioning information response to the requesting node.

Another non-limiting aspect of the disclosed subject matter is directed to a computer readable medium which includes therein programming instructions executable by a computing device of a radio node to perform the method of the radio node as described above.

Another non-limiting aspect of the disclosed subject matter is directed to a radio node structured to assist in determining a position of a target wireless device. The radio node may be a wireless device (including the target device itself), or any of the radio network nodes. The radio node may comprise a communicator, a measurement manager, and a positioning data manager. The communicator may be structured to receive a positioning information request from a requesting node in which the positioning information request is related to positioning of the target wireless device. The measurement manager may be structured to obtain one or more first measurement configurations and one or more second measurement configurations based on the positioning information request, and to measure the first signals and the second signals corresponding to the first and second measurement configurations. The positioning manager may be structured to obtain a positioning information response based on measurement results, and to send the positioning information response to the requesting node.

Another non-limiting aspect of the disclosed subject matter is directed to a method performed at a network node to assist in positioning a target wireless device. The network node may be a radio network node, a positioning node, a measuring node, or any other network node capable of providing assistance. The method may include receiving a positioning information request from a requesting node, in which the request may be related to positioning of the target wireless device. The method may also include obtaining one or more first measurement configurations and one or more second measurement configurations based on the positioning information request. The first measurement configurations may specify configurations related to one or more first signals transmitted from a transmitting node and measured by a measuring node, and the second measurement configurations may specify configurations related to one or more second signals one transmitted from the same transmitting node and measured by the same measuring node. The method may further include sending a measurement request to the measuring node requesting measurements of the first and second signals corresponding to the first and second measurement configurations, and receiving a measurement report from the measuring node. The measurement report may comprise any combination of a first measurement component, a second measurement component, and a composite measurement. The method may yet further include obtaining a positioning information response based on the measurement report, and sending the positioning information response to the requesting node. The positioning information response may comprise any combination of a first measurement component, a second measurement component, a composite measurement, and a positioning result. The first measurement component may include measurements performed on the first signals and/or channels transmitted from the transmitting node and measured by the measuring node, in which the first measurement component is associated with the first measurement configurations. The second measurement component may include measurements performed on one or more second signals and/or channels transmitted from the transmitting node and measured by the measuring node, in which the second measurement component is associated with the second measurement configurations. Preferably, the first and second measurement configurations, as a whole, are different. The composite measurement may be based on at least the first and second measurement components. The positioning result may indicate positioning of the target wireless device. The method may additionally include sending the positioning information response to the requesting node.

Another non-limiting aspect of the disclosed subject matter is directed to a computer readable medium which includes therein programming instructions executable by a computing device of a network node to perform the method of the network node as described above.

Another non-limiting aspect of the disclosed subject matter is directed to a network node structured to assist in determining a position of a target wireless device. The network node may be a radio network node, a positioning node, a measuring node, or any other network node capable of providing assistance. The network node may comprise a communicator, a measurement manager, and a positioning data manager. The communicator may be structured to receive a positioning information request from a requesting node in which the positioning information request is related to positioning of the target wireless device. The measurement manager may be structured to obtain one or more first measurement configurations and one or more second measurement configurations based on the positioning information request, to send a measurement request to the measuring node requesting measurements of the first and second signals corresponding to the first and second measurement configurations, and to receive a measurement report from the measuring node. The positioning data manager may be structured to obtain a positioning information response based on the measurement report, and to send the positioning information response to the requesting node.

### DESCRIPTION OF THE DRAWINGS

The foregoing and other objects, features, and advantages of the disclosed subject matter will be apparent from the following more particular description of preferred embodiments as illustrated in the accompanying drawings in which reference characters refer to the same parts throughout the various views. The drawings are not necessarily to scale.

FIGS. 1a and 1b respectively illustrate examples of uplink and downlink positioning architectures in LTE;

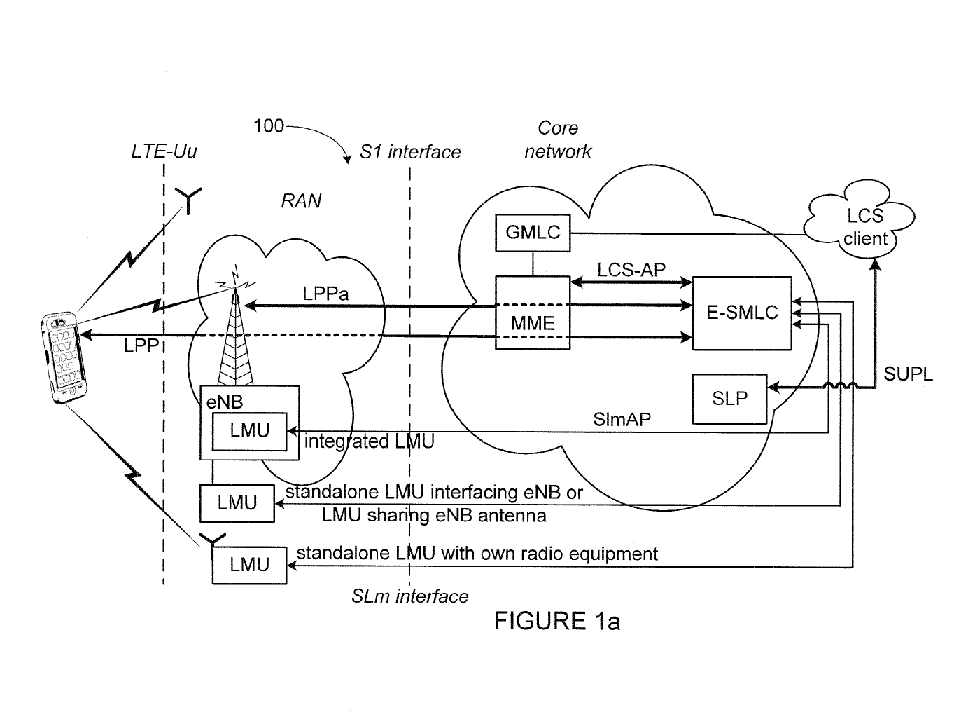

FIGS. 2 and 3 illustrate example embodiments of a network node;

FIGS. 4 and 5 illustrate example embodiments of a positioning node;

FIGS. 6 and 7 illustrate example embodiments of a coordinating node;

FIGS. 8 and 9 illustrate example embodiments of a measuring node;

FIGS. 10 and 11 illustrate example embodiments of a wireless device;

FIG. 12 illustrates an example scenario in which messages may be exchanged between nodes for positioning;

FIG. 13 illustrates a flow chart of an example method to obtain a positioning result of a target wireless device;

FIGS. 14 and 15 illustrate flow charts of example processes to obtain a composite measurement;

FIG. 16 illustrates a flow chart of an example process to obtain configuration differences;

FIG. 17 illustrates a flow chart of an example process to obtain a positioning result;

FIG. 18 illustrates a flow chart of an example method to assist in positioning of a target wireless device in a radio node;

FIG. 19 illustrates a flow chart of an example process to obtain positioning information response in a radio node;

FIG. 20 illustrates a flow chart of an example method to assist in positioning of a target wireless device in a network node; and

FIG. 21 illustrates a flow chart of an example process to obtain positioning information response a network node.

### DETAILED DESCRIPTION

For purposes of explanation and not limitation, specific details are set forth such as particular architectures, interfaces, techniques, and so on. However, it will be apparent to those skilled in the art that the technology described herein may be practiced in other embodiments that depart from these specific details. That is, those skilled in the art will be able to devise various arrangements which, although not explicitly described or shown herein, embody the principles of the described technology.

In some instances, detailed descriptions of well-known devices, circuits, and methods are omitted so as not to obscure the description with unnecessary details. All statements herein reciting principles, aspects, embodiments and examples are intended to encompass both structural and functional equivalents. Additionally, it is intended that such equivalents include both currently known equivalents as well as equivalents developed in the future, i.e., any elements developed that perform same function, regardless of structure.

Thus, for example, it will be appreciated that block diagrams herein can represent conceptual views of illustrative circuitry embodying principles of the technology. Similarly, it will be appreciated that any flow charts, state transition diagrams, pseudo code, and the like represent various processes which may be substantially represented in computer readable medium and executed by a computer or processor, whether or not such computer or processor is explicitly shown.

Functions of various elements including functional blocks labeled or described as “processors” or “controllers” may be provided through dedicated hardware as well as hardware capable of executing associated software. When provided by a processor, functions may be provided by a single dedicated processor, by a single shared processor, or by a plurality of individual processors, some of which may be shared or distributed. Moreover, explicit use of term “processor” or “controller” should not be construed to refer exclusively to hardware capable of executing software, and may include, without limitation, digital signal processor (shortened to “DSP”) hardware, read only memory (shortened to “ROM”) for storing software, random access memory (shortened to RAM), and non-volatile storage.

Although terminologies from 3GPP are used in this disclosure for explanation purposes, this should not be seen as limiting the scope of the disclosed subject matter to only the aforementioned system. Other wireless systems, including WCDMA, WiMax, UMB, GSM and others may benefit from exploiting the ideas covered within this disclosure. Furthermore, the embodiments described herein may also apply in wireless networks supporting more than one radio access technology (RAT).

In the background section, it is indicated that in LTE for example, LMUs can make UTDOA measurements on SRSs (Sounding Reference Signal) from UEs. To detect an SRS signal, a LMU needs a number of SRS parameters to correlate the received signals. The SRS parameters can be provided in an assistance data from the positioning node (e.g., E-SMLC) to the LMU. However, these parameters may generally be not known to the positioning node. Thus, the positioning node would need to obtain the SRS parameters from the eNodeB configuring the SRS to be transmitted by the UE and measured by LMU. After receiving the parameters, the LMU makes measurements on the reference signals transmitted from the UEs for position determination.

At least the following issues are identified with respect to conventional solutions. First, currently existing standards define relative measurements. Unfortunately, such measurements are relevant for positioning only with respect to another cell. Existing finger printing methods (e.g., CID) could be used for positioning. However, classical fingerprinting methods rely on relatively static transmitter and receiver configurations, which can lead to inaccuracies as systems change.

To address one or more issues related to existing solutions, the disclosed subject matter may include (among others) the following aspects:
Obtaining composite measurements;
Signaling (or providing) composite measurements;
Using composite measurements for positioning.

The signaling described herein can be via direct links or logical links (e.g., via higher layer protocols and/or via one or more network nodes). For example, in LTE in the case of signaling between the E-SMLC and the LCS Client, the positioning result may be transferred via multiple nodes (at least via MME and/or GMLC).

So as to contextualize the description, the following are provided. A radio node may be characterized by its ability to transmit and/or receive radio signals and it includes at least a transmitting or receiving antenna. Examples of radio nodes include a UE and a radio network node (see corresponding descriptions below).

In this description, wireless device and UE may be used interchangeably. A UE can be any device equipped with a radio interface and capable of at least transmitting to and/or receiving radio signals from another radio node. A UE may also be capable of receiving signal and demodulate it. Note that even some radio network nodes, e.g., femto BS (aka home BS), may also be equipped with a UE-like interface. Some example of “UE” that are to be understood in a general sense are PDA, laptop, mobile, a tablet device, sensor, fixed relay, mobile relay, any radio network node equipped with a UE-like interface (e.g., small RBS, eNodeB, femto BS).

A radio network node can be a radio node included in a radio communications network. A radio network node may be capable of receiving and/or transmitting radio signals in one or more frequencies, and may operate in single-RAT, multi-RAT or multi-standard mode. A radio network node, including eNodeB, RRH, RRU, or transmitting-only/receiving-only radio network nodes, may or may not create own cell. Some examples of radio network nodes not creating own cell include beacon devices (which can transmit configured radio signals) and measuring nodes (which can receive and perform measurements on certain signals (e.g., location measurement units, LMUs)). Such radio network node may also share a cell or use the cell ID with another radio node which creates own cell, and/or it may operate in a cell sector or may be associated with a radio network node creating own cell.

More than one cell or cell sectors (commonly named in the described embodiments by a generalized term “cell” which may be understood as a cell or its logical or geographical part) may be associated with one radio network node. Further, one or more serving cells (in DL and/or UL) may be configured for a UE, e.g., in a carrier aggregation system where a UE may have one Primary Cell (PCell) and one or more Secondary Cells (SCells). A cell may also be a virtual cell (e.g., characterized by a cell ID but not provide a full cell-like service) associated with a transmit node.

A network node may be any radio network node (see the corresponding description) or core network node. Some non-limiting examples of a network node are an eNodeB (also radio network node), RNC, positioning node, MME, PSAP, SON node, MDT node, coordinating node, a gateway node (e.g., PGW or SGW or LMU gateway or femto gateway), and O&M node.

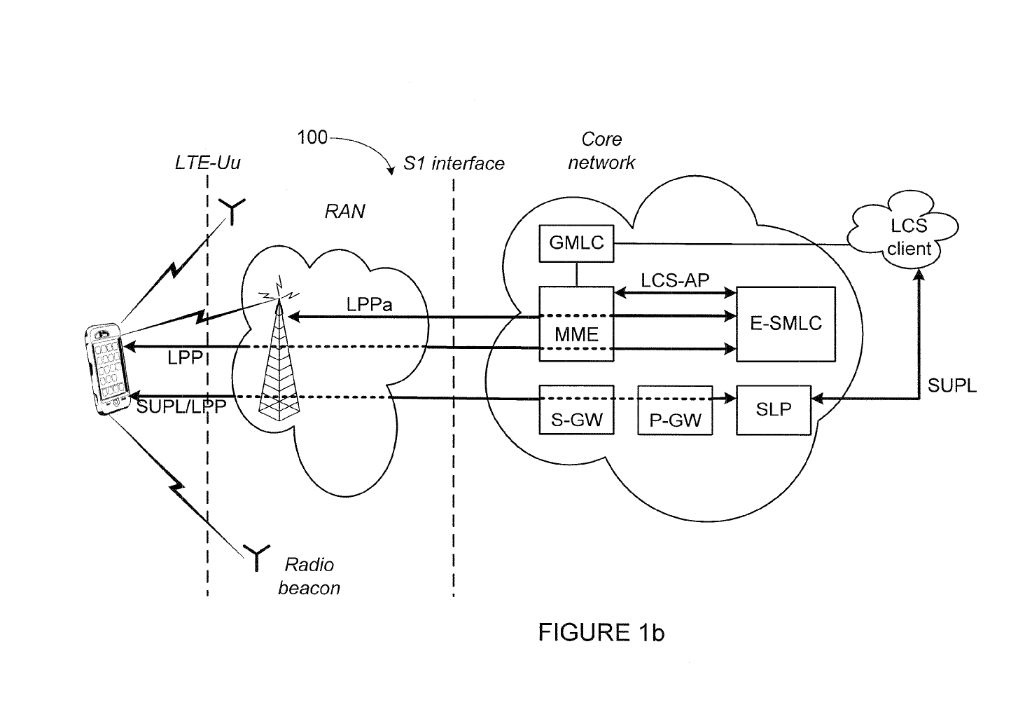

FIG. 2 illustrates an example embodiment of a network node 200 according to an aspect of the disclosed subject matter. As seen in FIG. 2, the network node 200 may include a controller 210, a communicator 220, a measurement manager 230, a positioning data manager 240, an assistance data manager 250, and a configuration manager 260. The communicator 220 may be structured to perform wired and/or wireless communication with other nodes and/or wireless devices using any of the protocols as described above. The measurement manager 230 may be structured to obtain, process and otherwise manage measurements made on signals/channels including measurements for positioning. The positioning data manager 240 may be structured to receive and/or provide positioning data to other nodes and/or wireless devices. The positioning data manager 240 may also be structured to calculate or otherwise determine positions of target wireless devices. The assistance data manager 250 may be structured to manage assistance data including receiving and/or sending assistance data from/to other nodes in the network. The configuration manager 260 may be structured to receive, provide, and otherwise manage configuration information of measurement components. The controller 210 may be structured to control the overall operation of the network node. Capabilities structured into each component device of the network node 200 will be further provided below in the descriptions of one or more proposed methods of the disclosed subject matter.

FIG. 2 provides a logical view of the network node 200 and the component devices included therein. It is not strictly necessary that each device be implemented as physically separate modules. Some or all component devices may be combined in a physical module. Also, the devices of the network node 200 need not be implemented strictly in hardware. It is envisioned that the component devices can be implemented through any combination of hardware and software. For example, as illustrated in FIG. 3, the network node 300 may include one or more processors 310, one or more storages 320 (internal, external, or both), and one or both of a wireless interface 330 (e.g., in case of a radio network node) and a network interface 340 (in case of a radio network node or a core network node). The processor(s) 310 may be structured to execute program instructions to perform the functions of one or more of the network node devices. The instructions may be stored in a non-transitory storage medium or in firmware (e.g., ROM, RAM, flash) (denoted as storage). Note that the program instructions may also be received through wired and/or or wireless transitory medium via one or both of the wireless and network interfaces. The wireless interface 330 (e.g., a transceiver) may be structured to receive wireless signals from and send wireless signals to other radio nodes via one or more antennas 355. The network interface 340 may be included and structured to communicate with other radio and/or core network nodes.

Positioning node described in different embodiments can be a node with positioning functionality. For example in LTE, a positioning node may be understood as a positioning platform in the user plane (e.g., SLP in LTE) or a positioning node in the control plane (e.g., E-SMLC in LTE). A SLP may be comprised of SLC and SPC, where SPC may also include a proprietary interface with E-SMLC. Positioning functionality may be split among two or more nodes, e.g., there may be a gateway node between LMUs and E-SMLC, where the gateway node may be a radio base station or another network node; in this case, the term “positioning node” may relate to E-SMLC and the gateway node. In a testing environment, a positioning node may be a simulator or emulating test equipment.

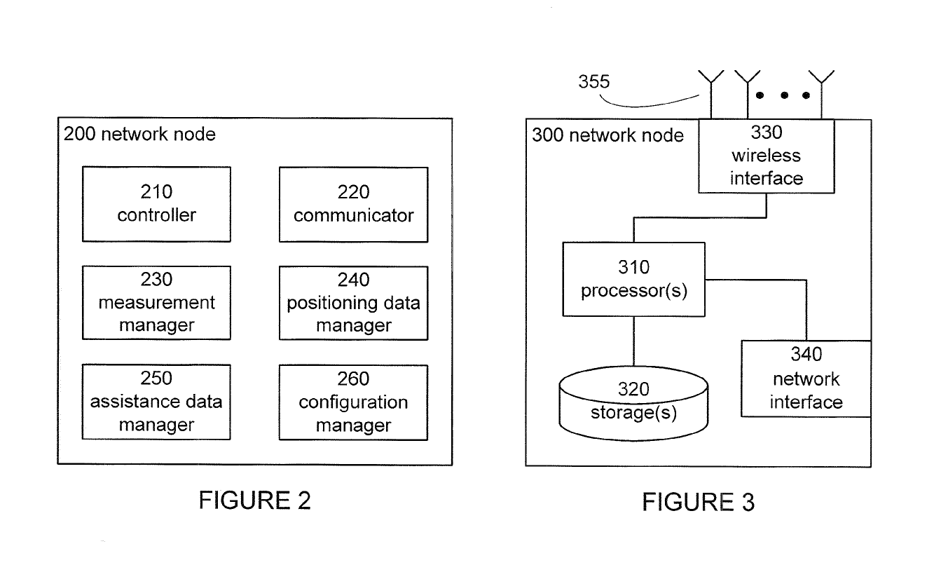

FIG. 4 illustrates an example embodiment of a positioning node 400 according to an aspect of the disclosed subject matter. As seen in FIG. 4, positioning node 400 may include a controller 410, a communicator 420, a measurement manager 430, a positioning data manager 440, an assistance data manager 450, a configuration manager 460, and one or both of a control plane operator 470 and a user plane operator 480. The communicator 420 may be structured to perform wired and/or wireless communication with other nodes and/or wireless devices using any of the protocols as described above. The measurement manager 430 may be structured to obtain, process and otherwise manage measurements made on signals/channels including measurements for positioning. The positioning data manager 440 may be structured to receive and/or provide positioning data to other nodes and/or wireless devices. The positioning data manager 440 may also be structured to calculate or otherwise determine positions of target wireless devices. The assistance data manager 450 may be structured to obtain assistance data from and/or provide assistance data to other nodes and/or wireless devices. The configuration manager 460 may be structured to manage measurement configurations of other nodes including measuring nodes such as LMU. The control plane operator 470 may be structured to perform control plane positioning procedures and/or interface with control plane architectures. The user plane operator 480 may be structured to perform user plane positioning procedures and/or interface with user plane architectures. The controller 410 may be structured to control the overall operation of the positioning node. It should be noted that each of the control plane operator 470 and the user plane operator 480 may include its own controller. But in another aspect, the controller 410 may include one or both of the control plane controller and the user plane controller. Capabilities structured into each component device of the positioning node 400 will be further provided below in the descriptions of one or more proposed methods of the disclosed subject matter.

FIG. 4 provides a logical view of the positioning node 400 and the component devices included therein. It is not strictly necessary that each device be implemented as physically separate modules. Some or all component devices may be combined in a physical module. Also, the devices of the positioning node 400 need not be implemented strictly in hardware. It is envisioned that the component devices can be implemented through any combination of hardware and software. For example, as illustrated in FIG. 5, the positioning node 500 may include one or more processors 510, one or more storages 520 (internal, external, or both), and one or both of a wireless interface 530 (e.g., in case of a radio network node) and a network interface 540 (in case of a radio network node or a core network node). The processor(s) 510 may be structured to execute program instructions to perform the functions of one or more of the positioning node devices. The instructions may be stored in a non-transitory storage medium or in firmware (e.g., ROM, RAM, flash) (denoted as storage). Note that the program instructions may also be received through wired and/or or wireless transitory medium via one or both of the wireless and network interfaces. The wireless interface 530 (e.g., a transceiver) may be structured to receive wireless signals from and send wireless signals to other radio nodes via one or more antennas 555. The network interface 540 may be included and structured to communicate with other radio and/or core network nodes.

The term “coordinating node” used herein can be a network and/or node, which coordinates radio resources with one or more radio nodes. Some examples of the coordinating node are network monitoring and configuration node, OSS node, O&M, MDT node, SON node, positioning node, MME, a gateway node such as Packet Data Network Gateway (PGW) or Serving Gateway (SGW) network node or femto gateway node, a macro node coordinating smaller radio nodes associated with it, eNodeB coordinating resources with other eNodeBs, etc.

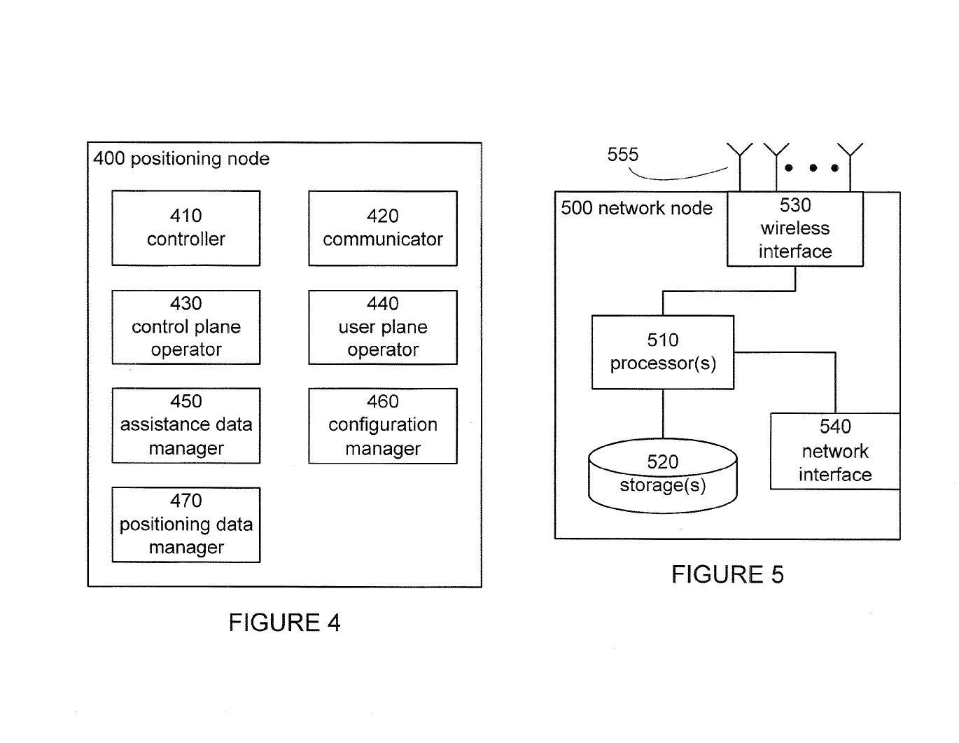

FIG. 6 illustrates an example embodiment 600 of a coordinating node according to an aspect of the disclosed subject matter. The coordinating node 600 may include a controller 610, a communicator 620, a prioritizer 630, a measuring node selector 640, an association manager 650, and a configuration manager 660. The communicator 610 may be structured to perform wired and/or wireless communication with other nodes and/or wireless devices using any of the protocols as described above. The prioritizer 630 may be structured to prioritize among positioning nodes, measuring nodes, and PLMNs. The measuring node selector 640 may be structured to select a set of measuring nodes, e.g., for cross-PLMN coordination. The association manager 650 may be structured to associate and/or determine associations among the measuring nodes, the positioning nodes, and the PLMNs. The configuration manager 660 may be structured to receive, provide, and otherwise manage configuration information of measurement components. The controller 610 may be structured to control the overall operation of the coordinating node. Capabilities structured into each component device of the coordinating node 600 will be further provided below in the descriptions of one or more proposed methods of the disclosed subject matter.

FIG. 6 provides a logical view of the coordinating node 600 and the component devices included therein. It is not strictly necessary that each device be implemented as physically separate modules. Some or all component devices may be combined in a physical module. Also, the devices of the coordinating node 600 need not be implemented strictly in hardware. It is envisioned that the component devices can be implemented through any combination of hardware and software. For example, as illustrated in FIG. 7, the coordinating node 700 may include one or more processors 710, one or more storages 720 (internal, external, or both), and one or both of a wireless interface 730 (e.g., in case of a radio network node) and a network interface 740 (in case of a radio network node or a core network node). The processor(s) 710 may be structured to execute program instructions to perform the functions of one or more of the positioning node devices. The instructions may be stored in a non-transitory storage medium or in firmware (e.g., ROM, RAM, flash) (denoted as storage). Note that the program instructions may also be received through wired and/or or wireless transitory medium via one or both of the wireless and network interfaces. The wireless interface 730 (e.g., a transceiver) may be structured to receive wireless signals from and send wireless signals to other radio nodes via one or more antennas 755. The network interface 740 may be included and structured to communicate with other radio and/or core network nodes.

Measuring node can be a radio node that performs positioning measurements, and can be a wireless device or a radio network node (e.g., LMU or eNodeB). Examples of positioning measurements, i.e., radio measurements used for positioning, include timing measurements (e.g., TDOA, TOA, timing advance, UE Rx-Tx, eNodeB Rx-Tx, RSTD defined for OTDOA, UL RTOA defined for UTDOA, etc.), angle measurements (e.g., AoA), received signal strength and received signal quality measurements. UL measurements are typically performed by a radio network node on signals/channels transmitted by one or more wireless devices. DL measurements are typically performed by a wireless device on signals/channels transmitted by one or more radio network nodes.

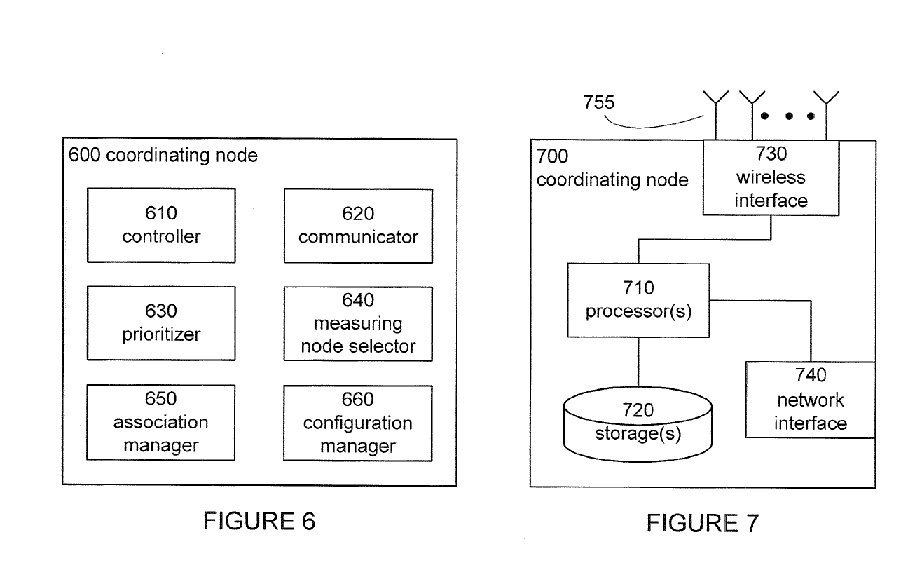

FIG. 8 illustrates an example embodiment of a measuring node 800 according to an aspect of the disclosed subject matter. As seen, the measuring node 800 may include a controller 810, a communicator 820, a measurement manager 830, a positioning data manager 840, and a configuration manager 850. The communicator 820 may be structured to perform wired and/or wireless communication with other nodes and/or wireless devices using any of the protocols as described above. The communicator 820 may also be structured to receive signals that are to be measured. The positioning data manager 840 may be structured to determine parameters or characteristics of the signals received by the communicator 820. Such parameters include timing, power, angle of arrival, etc of the signals. The measurement manager 830 may be structured to obtain, process and otherwise manage measurements made on signals/channels including measurements for positioning. The configuration manager 850 may be structured to receive, provide, and otherwise manage configuration information of measurement components. The controller 810 may be structured to control the overall operation of the measuring node. Capabilities structured into each component device of the measuring node 800 will be further provided below in the descriptions of one or more proposed methods of the disclosed subject matter.

FIG. 8 provides a logical view of the measuring node 800 and the component devices included therein. It is not strictly necessary that each device be implemented as physically separate modules. Some or all component devices may be combined in a physical module. Also, the devices of the measuring node 800 need not be implemented strictly in hardware. It is envisioned that the component devices can be implemented through any combination of hardware and software. For example, as illustrated in FIG. 9, the measuring node 900 may include one or more processors 910, one or more storages 920 (internal, external, or both), and one or both of a wireless interface 930 (e.g., in case of a radio network node) and a network interface 940 (in case of a radio network node or a core network node). The processor(s) 910 may be structured to execute program instructions to perform the functions of one or more of the positioning node devices. The instructions may be stored in a non-transitory storage medium or in firmware (e.g., ROM, RAM, flash) (denoted as storage). Note that the program instructions may also be received through wired and/or or wireless transitory medium via one or both of the wireless and network interfaces. The wireless interface 930 (e.g., a transceiver) may be structured to receive wireless signals from and send wireless signals to other radio nodes via one or more antennas 955. The network interface 940 may be included and structured to communicate with other radio and/or core network nodes.

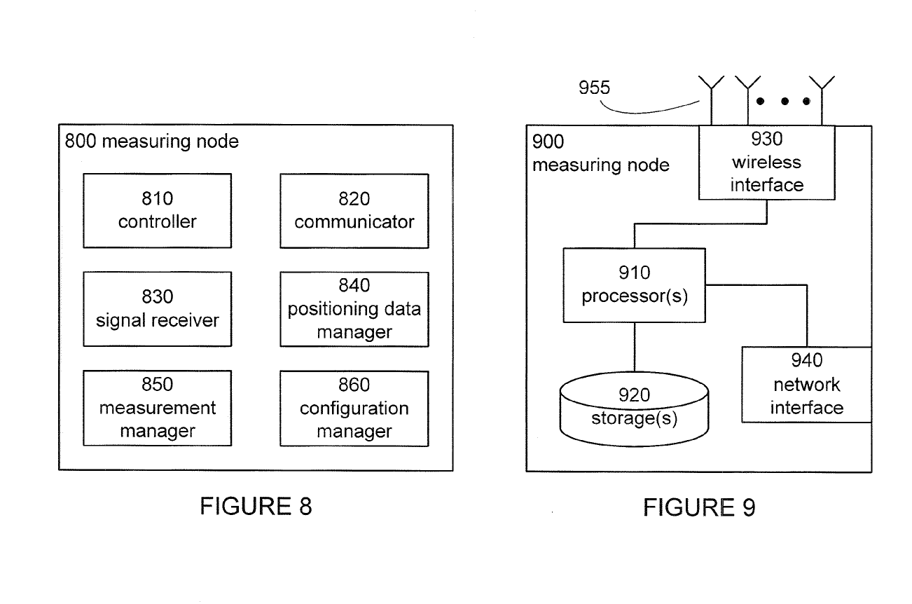

FIG. 10 illustrates an example embodiment 1000 of a wireless device such as a UE. The wireless device 1000 may include a controller 1010, a communicator 1020, a signal generator 1030, a measurement manager 1040, assistance data manager 1050, and a positioning data manager. The communicator 1020 may be structured to perform wireless communication with other nodes and/or or wireless terminals using any of the protocols as described above. The communicator 1020 may also be structured to receive signals that are to be measured. The signal generator 1030 may be structured to generate signals used for UL measurement, e.g., SRS. Note that data signals may also be used for measurements. The measurement manager 1040 may be structured to perform measurements of signals from radio network nodes or from other wireless terminals and to provide feedback to the network regarding the measurements. The assistance data manager 1050 may be structured to provide assistance to the network and/or receive assistance data from the network. The positioning data manager 1060 may be structured receive positioning data and/or provide positioning data to the network. The controller 1010 may be structured to control the overall operation of the wireless device. The positioning data manager 1060 may also be structured to calculate the location of the wireless device 1000.

FIG. 10 provides a logical view of the wireless device 1000 and the component devices included therein. It is not strictly necessary that each device be implemented as physically separate modules. Some or all component devices may be combined in a physical module. Also, the devices of the wireless device 1000 need not be implemented strictly in hardware. It is envisioned that the component devices can be implemented through any combination of hardware and software. For example, as illustrated in FIG. 11, the wireless device 1100 may include one or more processors 1110, one or more storages 1120 (internal, external, or both), and a wireless interface 1130. The processor(s) 1110 may be structured to execute program instructions to perform the functions of one or more of the positioning node devices. The instructions may be stored in a non-transitory storage medium or in firmware (e.g., ROM, RAM, flash) (denoted as storage). Note that the program instructions may also be received through wired and/or or wireless transitory medium via one or both of the wireless and network interfaces. The wireless interface 1130 (e.g., a transceiver) may be structured to receive wireless signals from and send wireless signals to other radio nodes via one or more antennas 1155.

The signaling described herein can be either via direct links or logical links (e.g., via higher layer protocols and/or via one or more network and/or radio nodes). For example, signaling from a coordinating node to a UE may also pass another network node, e.g., a radio network node.

The term “subframe” used in the embodiments described herein (typically related to LTE) is an example resource in the time domain, and in general it may be any predefined time instance or time period.

The described embodiments are not limited to LTE, but may apply with any radio access network (RAN), single- or multi-RAT. Some other RAT examples are LTE-Advanced, UMTS, HSPA, GSM, cdma2000, WiMAX, and WiFi.

As indicated above, for positioning of LCS targets, or more generally for positioning of target wireless devices, the disclosed subject matter includes at least the following aspects:
Obtaining composite measurements;
Signaling (or providing) composite measurements;
Using composite measurements for positioning.

According to a non-limiting aspect of the disclosed subject matter, a composite measurement can be used for positioning. The composite measurement may be a result of or otherwise based on a plurality of measurement components, i.e., based on at least two measurement components. Each measurement component may include measurements performed on signals/channels transmitted by a transmitting node and received by a receiving node. For brevity and ease of expression, the term “signals of interest” or simply “signals” will be used to refer to the signals/channels that are measured to obtain the measurement components. Thus, the receiving node may be a measuring node, or at least a node capable of measuring the signals of interest.

Each measurement component may be associated with one or more measurement configurations in which each measurement configuration may be one of several measurement configuration types, examples of which include (among others) a resource type, a signal type, a transmitter type, and a receiver type. In one embodiment, the measurement configurations associated with each measurement component may comprise (among others) any one or more of:
Resource configuration (of the resource type configuration);
Signal configuration (of the signal type configuration);
Transmitter configuration (of the transmitter type configuration);
Receiver configuration (of the receiver type configuration).

### Resource Type Configuration

Resource type configurations may specify (or otherwise characterize) configurations of resources used to transmit the signals of interest for positioning. These resources may include time and/or frequency resources. Time resources may comprise a set of time instances, e.g., a time-domain pattern, a set of time-domain resources determined by a pre-defined rule and/or by a standard. Frequency resources may comprise a set of frequency resources, e.g., a frequency-domain pattern, bandwidth, a set of subcarriers, a set of frequency-domain resources determined by a pre-defined rule, etc. Time and frequency resources may also be determined jointly, e.g., by a pre-defined rule or by a configured pattern.

The time and/or frequency resources may comprise transmission and/or measurement resources:
Transmission resources may comprise a set of resources when the signals of interest are transmitted by the transmitting node. In one example, a set of transmission resources may be comprised in a transmit pattern;
Measurement resources may comprise a set of resources when the signals of interest are measured by the measuring node. In one example, the set of measurement resources may be comprised in a measurement pattern.

The following are some (non-exhaustive) examples of time-domain patterns:
A time-domain measurement resource restriction pattern—a measurement pattern used for inter-cell interference coordination (ICIC). This measurement pattern may be signaled by an eNodeB over a higher layer (a layer above the physical layer such as RRC) to a UE (e.g., comprising 40 bits in FDD and 20/60/70 bits in TDD). The restriction pattern may indicate subframes which typically have more preferred interference conditions than other subframes for UE measurement purposes;
Almost Blank Subframes (ABS) pattern—a transmission pattern used by an eNodeB for ICIC. This transmission pattern may be exchanged among eNodeBs;
A pattern of positioning subframes;
A Positioning Reference Signal (PRS) transmission pattern.

### Signal Type Configuration

Configurations of the signal type may specify (or otherwise characterize) configurations of one or more signals of interest. For ease of expression, “signals” will be used in a broad sense to include the concept of channels. Each signal may be downlink or uplink, and also each may be physical or logical. The following are some (non-exhaustive) examples:
Physical signals:
   Synchronization signals (e.g., PSS, SSS);
   Reference signals (e.g., CRS, PRS, CSI-RS, DM-RS);
Physical channels—PRACH, PDSCH, PBCH, PDCCH, PUSCH, PUCCH;
Logical channels—paging channel, control channel, data channel.

For each signal, the signal type configuration may comprise (among others) any one or more of:
Signal type;
Signal antenna port;
Signal sequence (e.g., characterized by a function of a number, where the number may be different for different signal configurations);
Signal code (e.g., scrambling code);
Signal transmit power.

In one embodiment, a signal type configuration may also be associated with a configuration of the transmitter (e.g., a CSI-RS sequence associated with a beam configuration, a CRS sequence associated with one antenna port and one location).

### Transmitter Type Configuration

Configurations of the transmitter type may specify (or otherwise characterize) configurations of a transmitting node transmitting one or more signals of interest. Each transmitter type configuration may comprise (among others) any one or more of:
Transmit antenna configuration (e.g., any one or more of an antenna diagram, antenna tilt, antenna azimuth, antenna elements and/or combinations of antenna elements, pre-configured antenna configuration index, etc);
Transmit beam configuration (e.g., any one or more of beam width, beam height, beam azimuth, pre-configured beam configuration index (e.g., corresponding to one beam elevation in a set of beam elevation configurations or one beam azimuth in a set of beam azimuth configurations, etc.));
Transmit power level;
Transmitter attenuation.

### Receiver Type Configuration

Configurations of the receiver type may specify (or otherwise characterize) configurations of a receiving node receiving one or more signals of interest. Each receiver type configuration may comprise (among others) any one or more of:
Receive antenna configuration (e.g., any one or more of an antenna diagram, antenna tilt, antenna azimuth, antenna elements and/or combinations of antenna elements, pre-configured antenna configuration index, etc);
Receive beam configuration (e.g., any one or more of beam width, beam height, beam azimuth, pre-configured beam configuration index (e.g., corresponding to one beam elevation in a set of beam elevation configurations or one beam azimuth in a set of beam azimuth configurations, etc.));
Receiver attenuation.

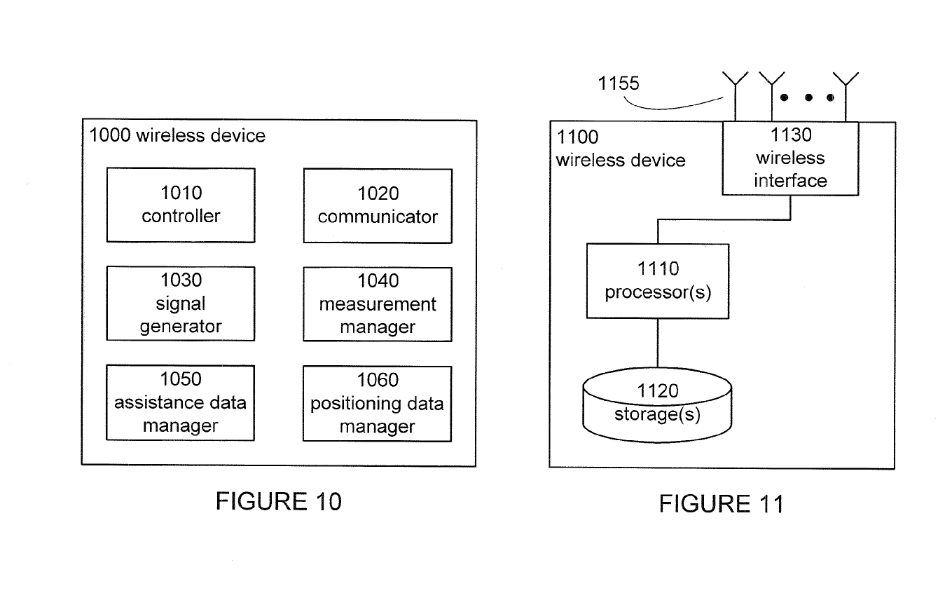

FIG. 12 illustrates an example scenario in which messages may be exchanged between nodes for positioning purposes. Messages may be exchanged between nodes of the same network. But as illustrated in FIG. 12, messages (including position-related messages) may also be exchanged between nodes of different networks (e.g., different public land mobile network (PLMN)). In FIG. 12, two networks—first and second networks 1201, 1202—are illustrated. The first network 1201 comprises a first positioning node 1221 (e.g., E-SMLC, SLP) and a first measuring node 1231 (e.g., LMU, eNB). The second network 1202 comprises a second MME 1212, a second positioning node 1222, a second measuring node 1232, and a second radio node 1242 (e.g., eNB). There are also MME 1210 and a measuring node 1230 that are shared by the two networks. In this context, when a node is shared by multiple networks, this is an indication that the node can behave as if it is part of (i.e., native to) more than one network.

In the FIG. 12 scenario, it may be assumed that the UE 1250 is the target wireless device whose position is to be determined and is in communication with the eNB 1242 of the second network 1202. The target wireless device 1250 may belong to the first network 1201, the second network 1202, or to a third network not illustrated in the figure. For UL positioning, the target wireless device 1250 may be the transmitting node that transmits one or more signals of interest measured by one or more receiving nodes including any one or more of eNB 1242, LMU 1232, and LMU 1230.

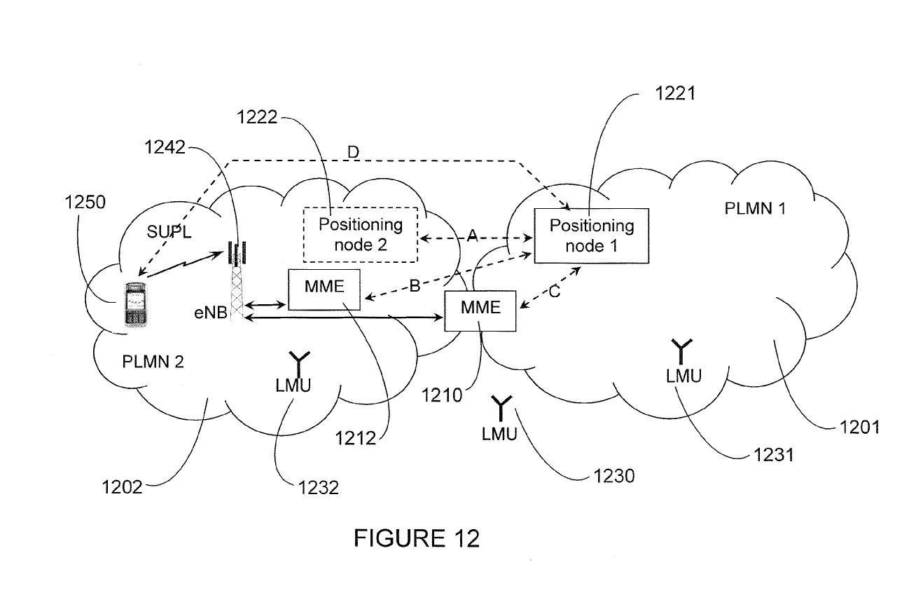

Determining the position of the UE 1250 may involve exchanges of position-related messages among multiple nodes of same or different networks. FIG. 13 illustrates a flow chart of an example method 1300 to determine a position of a target wireless device 1250. In one embodiment, a network node 200 may perform the method 1300. Examples of such network node 200 include a positioning node 400 (e.g., E-SMLC, SLP), a core network node (e.g., MME, GMLC, MSC, O&M, SON, MDT), or even a measuring node 800 (e.g., eNB, LMU). In another embodiment, a wireless device 1000, including the target wireless device 1250, or any other radio node may perform the method as well. For sake of brevity, it will be assumed that a node is performing the method.

In step 1310, the configuration manager 260 of the node may obtain a plurality of measurement configurations including the first and second measurement configurations. The measurement configurations will be described in concert with the description of the measurement components below. Each measurement configuration may be obtained in one of several ways. For example, for any individual measurement configuration, the configuration manager 260 may
Autonomously determine the configuration;
Determine the configuration based on a pre-defined rule;
Acquire a preconfigured configuration (e.g., from any one or more of a database, internal storage, external storage, another node);
Receive the configuration from another node.
   Optionally, in step 1315, the configuration manager 260 may store the obtained measurement configurations in an internal or external configurations database.

There can be differing scenarios in which the individual configuration is received from another node. In one scenario, a measuring node 800 may receive configuration information together with a measurement request from a positioning node 400 or from a coordinating node 600 (e.g., eNodeB). In another scenario, the node using the configuration information for obtaining the composite measurement or a positioning result based on the composite measurement may receive the configuration information together with a measurement report from any of a measuring node 800, a configuring node (e.g., requesting the configuration information from a serving eNodeB), another node that is aware of the configuration such as the transmitting node (e.g., wireless device transmitting in UL, eNodeB transmitting in DL), and another node forwarding the configuration information.

In step 1320, the measurement manager 230 (of the node) may obtain a composite measurement related to the target wireless device 1250. It is indicated above that the composite measurement may be a result of at least two measurement components, i.e., based on at least first and second measurement components. The composite measurement, based on the first and second measurement components, may be obtained in a measuring node 800 or in another node.

Recall that the first measurement component may be viewed as measurement or measurements performed on signals transmitted from a first transmitting node and received by a first receiving node (e.g., a measuring node). Similarly, the second measurement component may be viewed as measurement or measurements performed on signals transmitted from a second transmitting node and received by a second receiving node. The first and second transmitting nodes may be same or different, and the first and second receiving nodes may be same or different.

But in one aspect, both the first and second measurement components may be measurements performed on signals transmitted from a same transmitting node and received by a same receiving node. That is, it can be that the first and second transmitters are the same, and the first and second receivers are the same. For example, for UL positioning, the target wireless device 1250 may be the transmitter and a measuring node 800 (e.g., LMU, eNB) may be the receiver for the first and second measurement components.

Note that even if the transmitting nodes are the same, this does not necessarily imply that the first and second transmitter configurations are the same. Similarly, even if the receiving nodes are the same, the first and second receiver configurations may be the same or different.

The first and second measurement components may each comprise any one or more of:
Received signal power;
Received signal quality;
Total received power;
Total received noise;
Angle of arrival;
Timing;
Knowledge or profile about one or more radio channels.

The first and second measurement components may also each comprise any one or more of:
Downlink measurements;
Uplink measurements;
Measurements of radio signal/channel transmitted by/to a wireless device (e.g., in device-to-device communication).

Also as indicated above, the first measurement component may be associated with one or more first measurement configurations, which may specify configurations related to one or more signals (e.g., SRS) transmitted from a first transmitter (e.g., UE) and received by a first receiver (e.g., eNB, LMU). The first measurement configurations may include, among others, any one or more of a first resource configuration, a first signal configuration, a first transmitter configuration, and a first receiver configuration.

The second measurement component may be associated with one or more second measurement configurations which may specify configurations related to one or more signals transmitted from a second transmitter (e.g., UE) and received by a second receiver (e.g., eNB, LMU). The second measurement configurations may include, among others, any one or more of a second resource configuration, a second signal configuration, a second transmitter configuration, and a second receiver configuration.

The first and the second measurement configuration information may be used by a measuring node 800, by a node obtaining the composite measurement, and/or by a node receiving the composite measurement from the obtaining node or another node.

The first measurement configurations may include at least one configuration whose configuration type is in common with one of the second measurements configurations. For example, the first and second measurement configurations may respectively include first and second resource configurations, first and second signal configurations, first and second transmitter configurations, and/or first and second receiver configurations. For each common configuration type, the corresponding first and second measurement configurations may be same or different. However, it is preferred that for at least one common configuration type, the corresponding configurations themselves are different. In other words, at least one of the following should be true:
First and second resource configurations are different;
First and second signal configurations are different;
First and second transmitter configurations are different;
First and second receiver configurations are different.
   Thus, even though some of the individual configurations of a common type may be the same, it is preferred that the first and second measurement configurations are different from each other as a whole.

When composite measurements do not include differential measurements (explained later) or when a time resource configuration does not include a time-domain pattern, “at least one first configuration which is different” may be a configuration other than the time resource configuration.

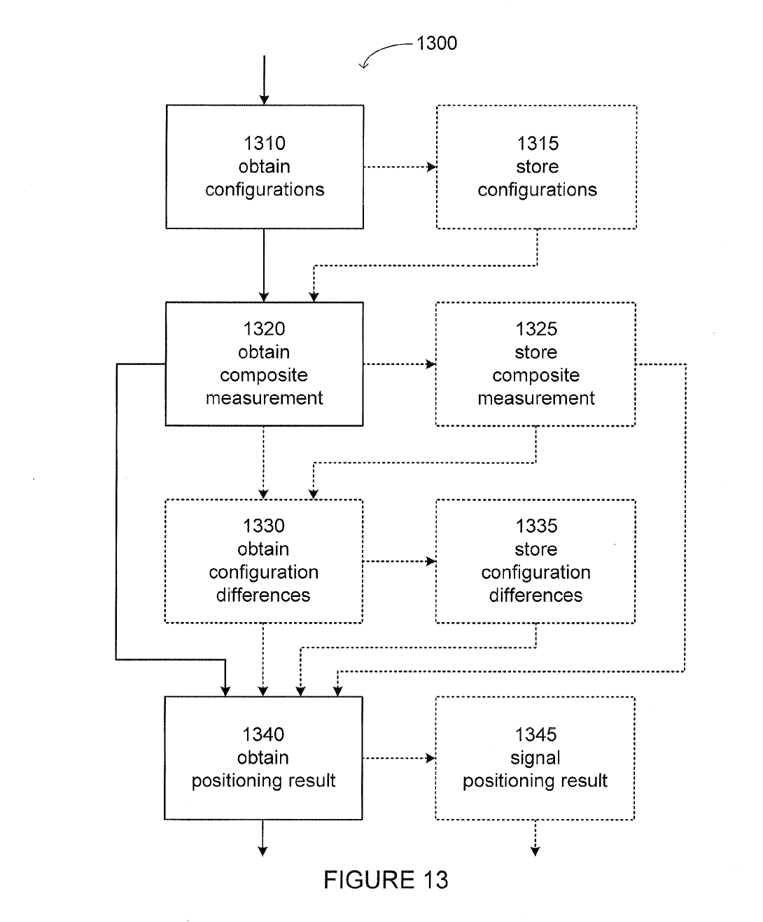

The composite measurement may be obtained (step 1320) in a multitude of ways. In one way, the node may receive the composite measurement from a measuring node 800, e.g., via the communicator 220. This is illustrated in FIG. 14. As seen, in step 1410, the measurement manager 230 may make a request for the composite measurement to a measuring node 800. In this step, the measurement manager 230 may provide one or both of the first and second measurement configurations to the measuring node 800. In step 1420, the measurement manager 230 may receive the requested composite measurement from the measuring node 800.

In another way, the individual measurement components may be obtained and the individual components may be combined to arrive at the composite measurement. This is illustrated in FIG. 15. In step 1510, the measurement manager 230 may obtain first measurement results (corresponding to the first measurement components) and/or second measurement results (corresponding to the second measurement components). In one embodiment, the measurement manager 230 may measure the first and/or second signals to obtain one or both measurement results, i.e., the node may be a measuring node 800 (e.g., eNB, LMU). The measuring node 800, being aware of the first and second configurations of time and/or frequency resources and/or signal configurations and/or transmitter configurations, may adapt its communicator to obtain the first and the second measurement components corresponding to the first and the second measurement configurations, respectively. The positioning data manager 840 may determine, e.g., any one or more of the received signal power, received signal quality, and so on. When the network node 200 is the node that performs the measurements, the network node 200 may be the receiver in the corresponding receiver configuration.

Alternatively, the node may acquire the first and/or the second measurement results from another node such as from a measuring node 800. In this instance, the assistance data manager 250 may provide (e.g., via the communicator 220) the first and/or second measurement configurations (e.g., as part of a measurement request message) to the measuring node 800 in step 1530 so that the measuring node 800 may adapt its communicator 820 for receiving signals to be measured. In step 1540, the measurement manager 230 may receive the requested measurement components from the measuring node 800.

Once the first and second measurement components are obtained (either through measuring in step 1510 or from a measuring node 800 in steps 1530 and 1540), the measurement manager 230 may combine the measurement components may to obtain the composite measurement in step 1520. It should be noted that a measurement component itself can be a composite measurement. That is, one or both of the first and second measurement components may themselves be composite measurements.

The combining step 1520 to obtain the composite measurement may be performed in a measuring node 800 which may then report the composite measurement to another node. Alternatively, the measuring node 800 may use the composite measurement for positioning (e.g., delivered to an application exploiting positioning measurements). In another example, the measuring node may signal the two measurement components to another node, e.g., another wireless device, a radio network node (eNodeB), or a network node (e.g., positioning node, MDT, SON, etc.), and the receiving node may combine the two measurement components.

In an embodiment, the measurement manager 230 of the node may apply a combining function that combines the individual measurement components including the first and second measurement components to arrive at the composite measurement. That is, the composite measurement may be determined as a function of measurement components in the form of:

μ_{composite}=f(μ₁, μ₂, . . . , μᵢ, . . . ; w₁, w₂, . . . , wᵢ, . . . ) (1)

in which μ₁ composite represents the composite measurement, each μᵢ represents individual measurement components (μ₁ and μ₂ respectively representing first and second measurement components), and each wᵢ represents corresponding weights (w₁ and w₂ respectively representing first and second weights). The function may be in any form, e.g., linear or non-linear. Also, the composite measurement μ_{composite} may be a numerical value, a matrix, a vector, a list, a curve, and so on.

In one embodiment, the composite measurement μ_{composite} may be a differential measurement. For example, μ_{composite} may represent a difference or a ratio between the second and the first measurement components. In one example, the difference may be a difference of the two measurement components in logarithmic scale. In another example, the ratio may be a ratio of the two measurement components in linear scale.

When obtaining the differential measurement, there can be multiple ways of designating which of the two measurement components is the first and which is the second. For example, the designations may be pre-configured or determined based on a pre-defined rule (e.g., the strongest is the first) or may be even indicated in the signaling (e.g., together with the composite measurement when the composite measurement is signaled to another node or it may be indicated in the signaling from the node requesting the composite measurement).

Differential measurement may include a result of combining the measurement components, in which each measurement component is associated with a different time-domain pattern. For example, the first measurement component may be associated with positioning subframes and the second measurement component may be associated with non-positioning subframes. As another example, the first measurement component may be associated with a time-domain measurement resource restriction pattern and the second measurement component may be associated with a set of subframes that are not indicated for measurements by the time-domain measurement resource restriction pattern.

In addition thereto or instead of, the differential measurement may include combining the measurement components, in which each measurement component is associated with a different transmitter configuration. For example, the first measurement component may be associated with a first beam configuration of the transmitter, and the second measurement component may be associated with a second beam configuration of the transmitter in which the second beam configuration is different from the first beam configuration (e.g., due to different tilt).

In another embodiment, the composite measurement μ_{composite} may be an average of the measurement components. Alternatively, the composite measurement μ_{composite} may be a combination of weighted measurement of the individual measurement components. As an illustration, the composite measurement μ_{composite} may be a combination of weighted received signal powers where the first received signal power component is weighted with a weight w₁ and the second received signal power component is weighted with a weight w₂. Preferably, the weights are such that w₁ⁿ+w₂ⁿ=1, where n is any number. Note that some weights may be zero. For example, the first and the second measurement components, linearly combined with two equal positive weights, may be associated with two different beam configurations of the transmitter and two different signal configurations (e.g., the two different signal configurations may comprise two different signal sequences, also corresponding to the first and the second beam configurations, respectively).

In yet another embodiment, the composite measurement may be a subset of measurement components, where the subset may be selected based on a criteria (e.g., comparing a measurement component characteristic to a threshold), a pre-defined rule, or a parameter (e.g., a threshold) received from a network node 200. The subset may also comprise only one measurement component, e.g., the maximum, the minimum, the most common, or the one closest to a given percentile (e.g., of a CDF).

In yet another embodiment, a composite measurement may be a list of measurement components (e.g., a subset or all measurement components). Such composite measurement may be used as a whole (e.g., complete information over a set of time/frequency resources, where each measurement component does not overlap in frequency with another measurement component) by a network node which may also be a positioning node. This complete information may be compressed/approximated before delivery, to save bits.

The weights may be determined by the node performing the combining operation or by the measuring node or even by another node. The weights may be received from another node or may be determined based on at least one parameter received from another node. In another example, the weights may be determined based on a pre-defined rule, may be pre-configured, or may be retrieved from a local database. The weights may also be different, depending, e.g., on:
Relation between the amount of the first time and/or frequency resource configurations for the first and the second components;
The first and the second signal configuration;
The first and the second transmitter configuration;
The first and the second receiver configuration;
Historical measurement performance (e.g., accuracy and confidence level) of the first and the second measurement components;
At least one threshold to which the measurement components are compared to.

A benefit of the composite measurement is distinguishing between different configurations of the same node and delivering the difference information caused in measurements by the difference in configurations (e.g., with differential measurements). Another benefit is compactness of the exchanged and stored information and reduced signaling overhead. In one example, creating a composite measurement based on a set of measurement components may be viewed as a compression approach.

The combining function of (1) indicates that more than two measurement components may be combined to obtain the composite measurement. In an embodiment, each measurement component μᵢ may be used once in each composite measurement μ_{composite}. In another embodiment, one or more measurement components may be used as a reference measurement component.

Note that a reference component may be used more than once in each composite measurement. For example, the combining function make take the form of:

$${μ}_{composite} = {\sum }_{i} {w}_{i} ( {μ}_{i} - {μ}_{ref} ) \qquad ( 2 )$$

in which μ_{composite} represents the composite measurement, μ_{ref} represents the reference measurement component, μᵢ represent other measurement components, and wᵢ represent corresponding weights. Recall from above that a measurement component may be a composite measurement. In the combining function (2), each (μᵢ−μ_{ref}) dared may be considered to be a composite measurement, which is also a measurement component to the composite measurement μ_{composite} of (2).

Recall from above that the measuring node may report the composite measurement or the individual measurement components to another node. In other words, the measuring node (via the communicator 820) may signal to another node (e.g., positioning node, eNodeB, SON, MDT node, SON node, etc.) any one or more of:
The first and/or the second measurement components;
The composite measurement; and/or
Compressed or approximated version of the composite measurement.

In addition to the composite measurement or the measurement components, the measuring node may also signal configurations corresponding to the measurement components or the configuration difference determining the composite measurement.

Referring back to FIG. 13, the network node 200 (e.g., radio network node, positioning node, measuring node, core network node, MDT, O&M, SON, etc) may use the composite measurement to obtain a positioning result in step 1340. Wireless devices 1000 (e.g., UEs) may also make use of the composite measurement. It should be realized that the node using the composite measurement may or may not be the measuring node performing the measurements to obtain the first and second measurement components.

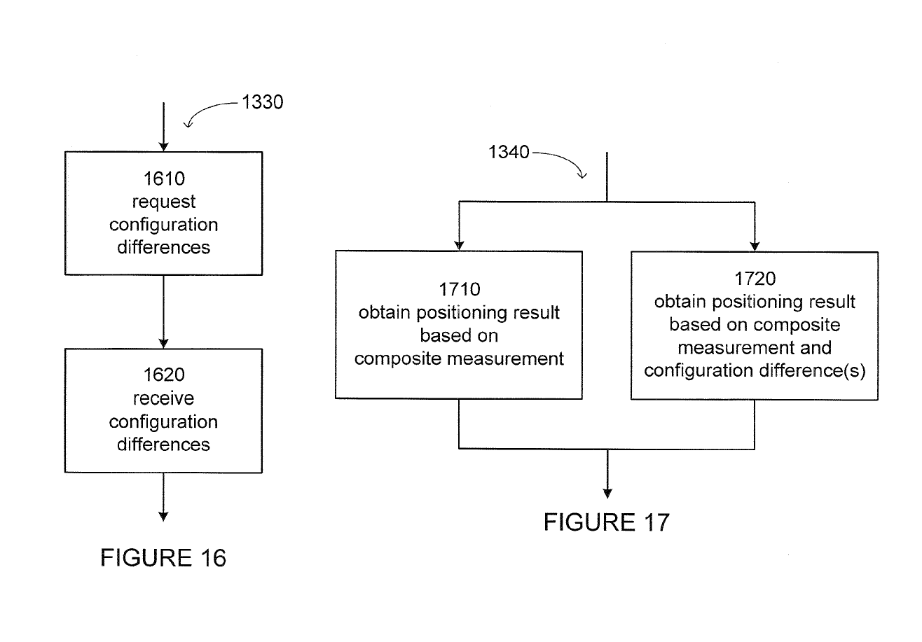

In one embodiment, the positioning data manager 240 may use the composite measurement to obtain the positioning result in step 1340 (see also FIG. 17, step 1710). The composite measurement may be used as a fingerprint for RF pattern matching, a fingerprinting-like positioning method, E-CID, AECID, DL or UL positioning, hybrid positioning, and so on. When used as a fingerprint, the composite measurement may serve as an indicator of a location or an area associated with a certain level or a range of composite measurements.

Optionally, in step 1325, the measurement manager 230 may store the obtained composite measurement, with or without processing, in an internal or external database, e.g., an AECID database, a RF pattern matching database, a RF fingerprinting database, etc. In such a database, which may be used when performing positioning of wireless devices, the composite measurement may also be associated with a location (e.g., obtained as a high-accuracy positioning result for the same LCS target for which the composite measurement was obtained or obtained by drive tests together with composite measurements). The database may be the same or different from the configurations database.

In another embodiment, the node using the composite measurement may, in step 1330, obtain differences between the first and the second measurement configuration associated with the first and the second measurement components (e.g., differences among the transmitter configurations, receiver configurations, and/or configurations of time and/or frequency resources).

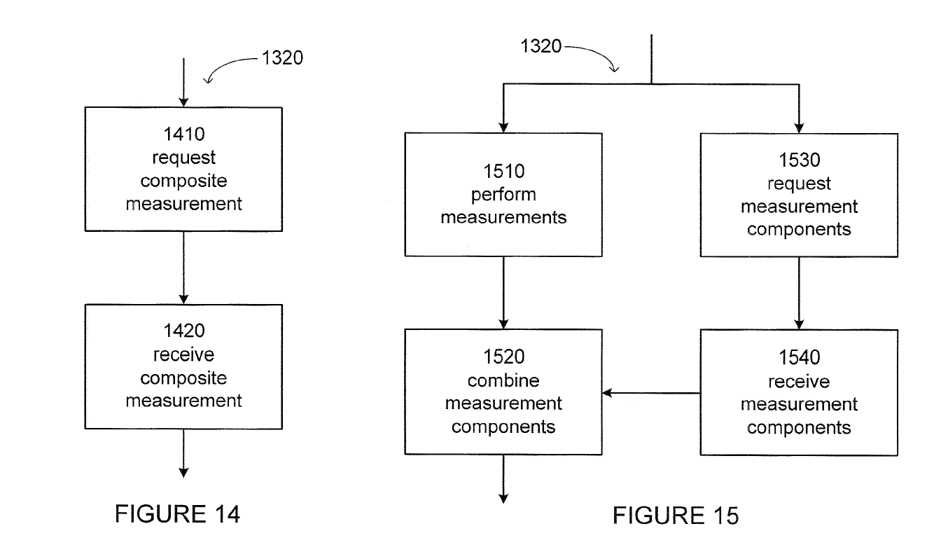

FIG. 16 illustrates a flow chart of an example process to obtain the configuration differences. In step 1610, the configuration manager may simply make a request to another node, e.g., via the communicator, for the configuration differences. The request may include the first and second measurement configurations or the request may be made to the node that is able to obtain the first and second measurement configurations on its own. In step 1620, the configuration manager of the node may receive the differences.

Referring back to FIG. 13, the configuration differences determining the composite measurement may be jointly used for positioning together with the composite measurement in step 1340 (see also step FIG. 17, step 1720). Optionally, in step 1335, the configuration difference may also be stored in the database and used as additional information for positioning (e.g., direction information, interfering neighbors information, etc.). In step 1345, the positioning of the target wireless device 1250 may be signaled to another device.

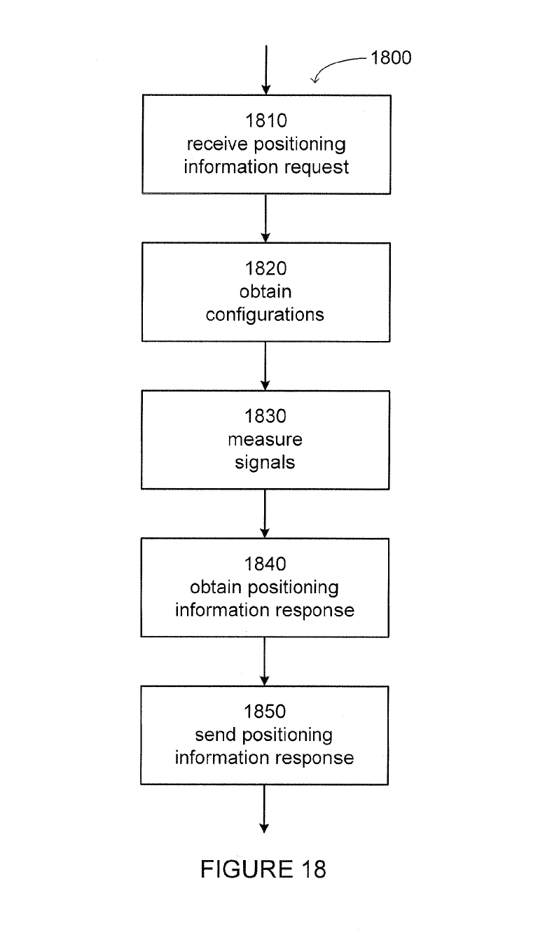

FIG. 18 illustrates a flow chart of a method 1800 performed by a radio node (e.g., eNB, target wireless device, measuring node) for assisting in positioning. In step 1810, the radio node may receive a positioning information request, which is related to positioning of a target wireless device 1250, from a requesting node (e.g., a network node 200). In step 1820, the measurement manager of the radio node may obtain the first and/or the second measurement configurations. This step may be similar to the step 1310 described above.

In step 1830, the radio node may perform measurements on the first and second signals corresponding to the first and second measurement configurations. Based on the measurement, the positioning data manager of the radio node may obtain a positioning response in step 1840 and send the positioning response to the requesting node in step 1850.

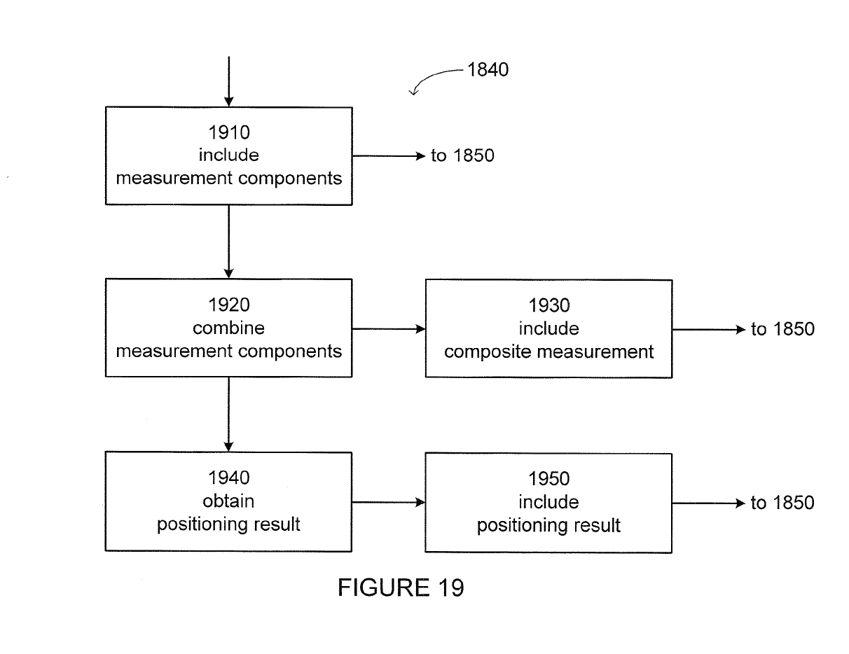

FIG. 19 illustrates what can be provided as the positioning response. In one embodiment, the radio node in step 1910 may simply provide the obtained first and/or the second measurement components obtained. In another embodiment, the radio node in step 1920 may combine the first and second measurement components to obtain the composite measurement, and the composite measurement may be provided in step 1930. In yet another embodiment, the radio node may determine the position of the target wireless device in step 1940 and provide the positioning result in step 1950. Note that in step 1850, any combination of the first measurement component, the second measurement component, the composite measurement, and the positioning result may be provided to the requesting node.

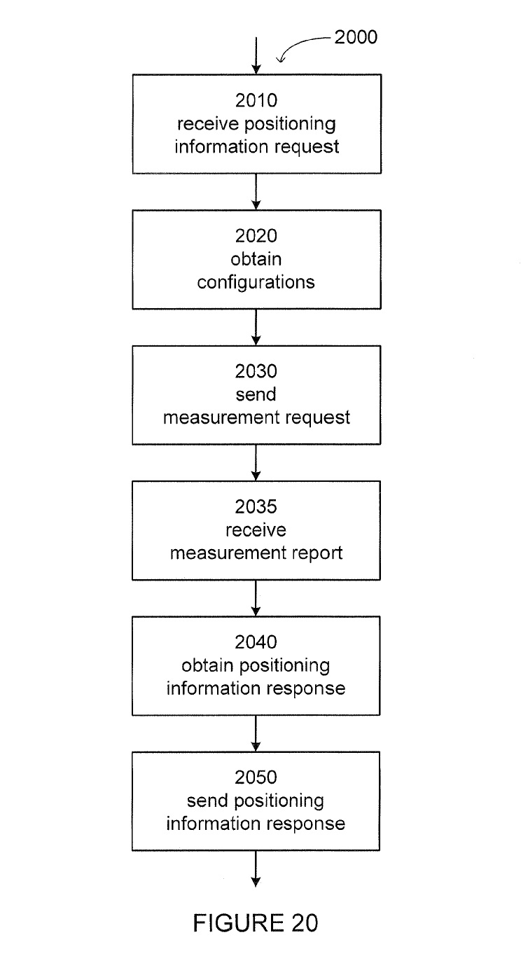

FIG. 20 illustrates a flow chart of a method 2000 performed by a network node (e.g., positioning node, core network node) for assisting in positioning. In step 2010, the network node may receive a positioning information request, which is related to positioning of a target wireless device 1250, from a requesting node (e.g., a network node 200). In step 2020, the network node may obtain the first and/or the second measurement configurations. This step may be similar to the step 1310 described above.

In step 2030, the network node may make a request to a measuring node 800 to perform measurements on the first and second signals corresponding to the first and second measurement configurations. In step 2035, the network node may receive a measurement report from the measuring node 800. The measurement report may include any combination of any combination of the first measurement component, the second measurement component and the composite measurement.

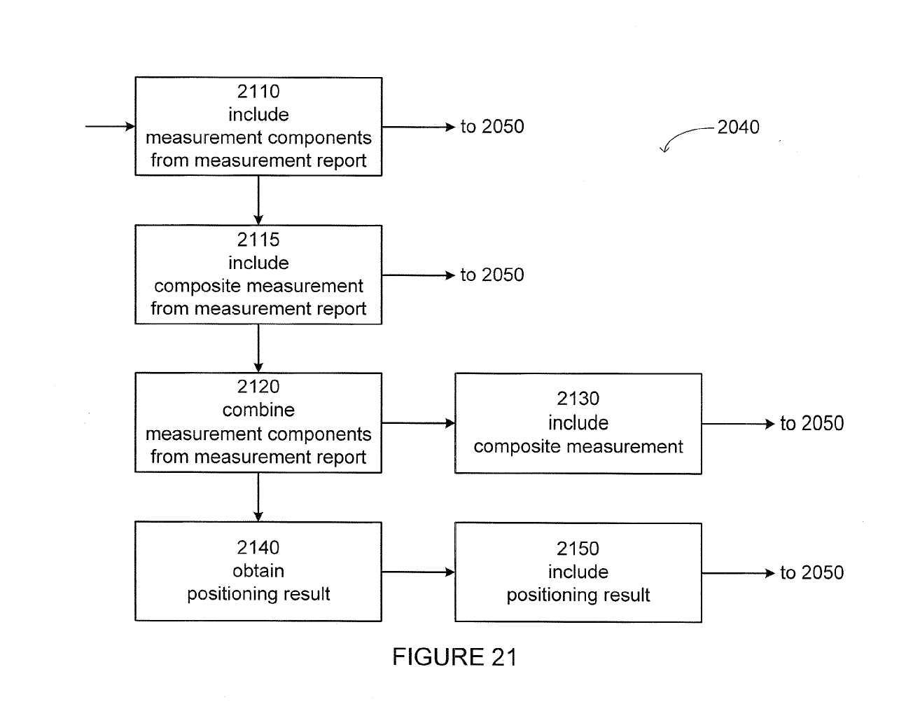

Based on the measurement report, the network node may obtain a positioning response in step 2040 and send the positioning response to the requesting node in step 2050. FIG. 21 illustrates what can be provided as the positioning response. In one embodiment, the measurement report may include the first and/or the second measurement components, and the network node in step 2110 may simply forward the measurement components to the requesting node. In another embodiment, the measurement report may include the composite measurement, and the network node in step 2115 may simply forward the composite measurement. Alternatively, when the measurement report includes the first and second measurement components, the network node in step 2120 may combine the first and second measurement components to obtain the composite measurement, and the composite measurement may be provided in step 2130. In yet another embodiment, the network node may determine the position of the target wireless device in step 2140 and provide the positioning result in step 2150. Note that in step 2050, any combination of the first measurement component, the second measurement component, the composite measurement, and the positioning result may be provided to the requesting node.

Although the description above contains many specifics, these should not be construed as limiting the scope of the disclosed subject matter but as merely providing illustrations of some of the presently preferred embodiments. Therefore, it will be appreciated that the scope of the disclosed subject matter fully encompasses other embodiments which may become obvious to those skilled in the art, and that the scope is accordingly not to be limited. All structural, and functional equivalents to the elements of the above-described preferred embodiment that are known to those of ordinary skill in the art are expressly incorporated herein by reference and are intended to be encompassed hereby. Moreover, it is not necessary for a device or method to address each and every problem described herein or sought to be solved by the present technology, for it to be encompassed hereby.

1. A method performed by a node to determine a position of a target wireless device, the method comprising:
obtaining a composite measurement related to the target wireless device; and
determining the position of the target wireless device based at least on the composite measurement,
wherein the composite measurement is based on at least first and second measurement components,
wherein the first measurement component includes measurements performed on one or more first physical signals/channels transmitted from a transmitting node and measured by a measuring node, the first measurement component being associated with one or more first measurement configurations specifying configurations related to the first signals,
wherein the second measurement component includes measurements performed on one or more second physical signals/channels transmitted from the same transmitting node and measured by the same measuring node, the second measurement component being associated with one or more second measurement configurations specifying configurations related to the second signals,
wherein the first and second measurement configurations, as a whole, are different.

2. The method of claim 1, further comprising obtaining the first and second measurement configurations,
wherein each of the first and second measurement configurations is obtained through at least one of:
autonomously determining the measurement configuration,
determining the measurement configuration based on a pre-defined rule,
acquiring a pre-configured configuration as the measurement configuration, and
receiving the measurement configuration from another node.

3. The method of claim 1, wherein the step of obtaining the composite measurement comprises:
requesting the measuring node for the composite measurement, the request including at least one of the first and second measurement configurations; and
receiving from the measuring node the composite measurement.

4. The method of claim 1, wherein the step of obtaining the composite measurement comprises:
acquiring the first and second measurement components respectively based on the first and second measurement configurations; and
combining the first and second measurements components,
wherein the step of acquiring the first and second measurement components comprises one of:
performing measurements on the first and second physical signals/channels respectively according to the first and second measurement configurations, or
acquiring from the measuring node the first and second measurement components, the request including at least one of the first and second measurement configurations.

5. The method of claim 1, further comprising:
obtaining configuration differences between the first measurement configurations and the second measurement configurations,
wherein in the step of determining the position of the target wireless device, the position is determined based on the configuration differences in addition to the composite measurement.

6. The method of claim 1,
wherein each of the first and second measurement configurations is of one configuration type among a plurality of configuration types,
wherein the configuration types include a resource configuration type characterizing configurations of resources used to transmit one or more signal(s) of interest for positioning, a signal configuration type characterizing configurations of the one or more signal(s) of interest, a transmitter configuration type characterizing configurations of a transmitting node transmitting the one or more signal(s) of interest, and a receiver configuration type characterizing configurations of a receiving node receiving the one or more signal(s) of interest,
wherein the first measurement configurations comprise any one or more of a first resource configuration of the resource configuration type, a first signal configuration of the signal configuration type, a first transmitter configuration of the transmitter configuration type, and a first receiver configuration of the receiver configuration type,
wherein the second measurement configuration comprise any one or more of a second resource configuration of the resource configuration type, a second signal configuration of the signal configuration type, a second transmitter configuration of the transmitter configuration type, and a second receiver configuration of the receiver configuration type, and
wherein the first and second measurement configurations includes at least one configuration type in common, in which the configurations of the common configuration type are different.

7. The method of claim 6,
wherein each resource configuration type of the resource configuration type comprises configurations of one or both of time and frequency resources,
wherein each signal configuration of the signal configuration type comprises configurations of any one or more of one or more physical signals in uplink and/or downlink, one or more physical channels in uplink and/or downlink, and one or more logical channels in uplink and/or downlink,
wherein each transmitter configuration of the transmitter configuration type as applied to transmission of signals/channels of interest comprises any one or more of, transmit antenna configuration, transmit beam configuration, transmit power level, and transmitter attenuation, and
wherein each receiver configuration of the receiver configuration type as applied to reception of signals/channels of interest comprises any one or more of receive antenna configuration, receive beam configuration, and receiver attenuation.

8. The method of claim 4,
wherein the step of combining the first and second measurement components comprises applying a combining function that combines the first and second measurement components to arrive at the composite measure,
wherein the combining function is in the form of μ_{composite}=f(μ₁, μ₂, . . . , μᵢ, . . . ; w₁, w₂, . . . , wᵢ, . . . ) in which μ_{composite} represents the composite measurement, μᵢ represent individual measurement components including μ₁ and μ₂ respectively representing first and second measurement components, and wᵢ represent corresponding weights including w₁ and w₂ respectively representing first and second weights.

9. The method of claim 1,
wherein the first measurement component comprises any one or more of a first received signal power, a first received signal quality, a first total received power, a first total received noise, a first angle-of-arrival, a first timing, and a first channel profile of one or more first radio channels, and
wherein the second measurement component comprises any one or more of a second received signal power, a second received signal quality, a second total received power, a second total received noise, a second angle-of-arrival, a second timing, and a second channel profile of one or more second radio channels.

10. A method in a radio node for assisting in positioning of a target wireless device, the method comprising:
receiving a positioning information request from a requesting node, the positioning information request being related to positioning of a target wireless device;
obtaining one or more first measurement configurations and one or more second measurement configurations based on the positioning information request, the first measurement configurations specifying configurations related to one or more first signals transmitted from a transmitting node, and the second measurement configurations specifying configurations related to one or more second signals one transmitted from the same transmitting node;
measuring the first signals and the second signals corresponding to the first and second measurement configurations; and
obtaining a positioning information response based on measurement results; and
sending the positioning information response to the requesting node,
wherein the positioning information response comprises any combination of a first measurement component, a second measurement component, a composite measurement, and a positioning result,
wherein the first measurement component includes measurements performed on the first signals/channels transmitted from the transmitting node and measured by the radio node, the first measurement component being associated with the first measurement configurations,
wherein the second measurement component includes measurements performed on one or more second signals/channels transmitted from the transmitting node and measured by the radio node, the second measurement component being associated with the second measurement configurations,
wherein the first and second measurement configurations, as a whole, are different,
wherein the composite measurement is based on at least the first and second measurement components, and
wherein the positioning result indicates positioning of the target wireless device.

11. The method of claim 10,
wherein each of the first and second measurement configurations is of one configuration type among a plurality of configuration types,
wherein the configuration types include a resource configuration type characterizing configurations of resources used to transmit one or more signal(s) of interest for positioning, a signal configuration type characterizing configurations of the one or more signal(s) of interest, a transmitter configuration type characterizing configurations of a transmitting node transmitting the one or more signal(s) of interest, and a receiver configuration type characterizing configurations of a receiving node receiving the one or more signal(s) of interest,
wherein the first measurement configurations comprise any one or more of a first resource configuration of the resource configuration type, a first signal configuration of the signal configuration type, a first transmitter configuration of the transmitter configuration type, and a first receiver configuration of the receiver configuration type,
wherein the second measurement configuration comprise any one or more of a second resource configuration of the resource configuration type, a second signal configuration of the signal configuration type, a second transmitter configuration of the transmitter configuration type, and a second receiver configuration of the receiver configuration type, and
wherein the first and second measurement configurations includes at least one configuration type in common, in which the configurations of the common configuration type are different.

12. The method of claim 10, wherein the step of obtaining the positioning information response comprises performing any one or more of:
including the first measurement component and/or the second measurement in the positioning information response;
combining the first and second measurement components to obtain the composite measurement, and including the composite measurement in the positioning information response; and/or
obtaining the positioning result at least based on the composite measurement, and including the positioning result in the positioning information response.

13. A method in a network node for assisting in positioning of a target wireless device, the method comprising:
receiving a positioning information request from a requesting node, the positioning information request being related to positioning of a target wireless device;
obtaining one or more first measurement configurations and one or more second measurement configurations based on the positioning information request, the first measurement configurations specifying configurations related to one or more first signals transmitted from a transmitting node and measured by a measuring node, and the second measurement configurations specifying configurations related to one or more second signals one transmitted from the same transmitting node and measured by the same measuring node;
sending a measurement request to the measuring node requesting measurements of the first and second signals corresponding to the first and second measurement configurations;
receiving a measurement report from the measuring node;
obtaining a positioning information response based on the measurement report;
sending the positioning information response to the requesting node,
wherein the measurement report comprises any combination of a first measurement component, a second measurement component, and a composite measurement,
wherein the positioning information response comprises any combination of the first measurement component, the second measurement component, the composite measurement, and the positioning result,
wherein the first measurement component includes measurements performed on the first signals/channels transmitted from the transmitting node and measured by the measuring node, the first measurement component being associated with the first measurement configurations,
wherein the second measurement component includes measurements performed on one or more second signals/channels transmitted from the transmitting node and measured by the measuring node, the second measurement component being associated with the second measurement configurations,
wherein the first and second measurement configurations, as a whole, are different,
wherein the composite measurement is based on at least the first and second measurement components, and
wherein the positioning result indicates positioning of the target wireless device.

14. The method of claim 13,
wherein each of the first and second measurement configurations is of one configuration type among a plurality of configuration types,
wherein the configuration types include a resource configuration type characterizing configurations of resources used to transmit one or more signal(s) of interest for positioning, a signal configuration type characterizing configurations of the one or more signal(s) of interest, a transmitter configuration type characterizing configurations of a transmitting node transmitting the one or more signal(s) of interest, and a receiver configuration type characterizing configurations of a receiving node receiving the one or more signal(s) of interest,
wherein the first measurement configurations comprise any one or more of a first resource configuration of the resource configuration type, a first signal configuration of the signal configuration type, a first transmitter configuration of the transmitter configuration type, and a first receiver configuration of the receiver configuration type,
wherein the second measurement configuration comprise any one or more of a second resource configuration of the resource configuration type, a second signal configuration of the signal configuration type, a second transmitter configuration of the transmitter configuration type, and a second receiver configuration of the receiver configuration type, and
wherein the first and second measurement configurations includes at least one configuration type in common, in which the configurations of the common configuration type are different.

15. The method of claim 13, wherein the step of obtaining the positioning information response comprises performing any one or more of:
including the first measurement component and/or the second measurement from the measurement report into the positioning information response;
including the composite measurement from the measurement report into the positioning information response;
combining the first and second measurement components from the measurement report to obtain the composite measurement, and including the combining result as the composite measurement into the positioning information response; and/or
obtaining the positioning result at least based on the composite measurement, and including the positioning result in the positioning information response.

16. A node structured to determine a position of a target wireless device, the node comprising:
a measurement manager structured to obtain a composite measurement related to the target wireless device, and
a positioning data manager structured to determine the position of the target wireless device based at least on the composite measurement,
wherein the composite measurement is based on at least first and second measurement components,
wherein the first measurement component includes measurements performed on one or more first physical signals/channels transmitted from a transmitting node and measured by a measuring node, the first measurement component being associated with one or more first measurement configurations specifying configurations related to the first signals,
wherein the second measurement component includes measurements performed on one or more second physical signals/channels transmitted from the same transmitting node and measured by the same measuring node, the second measurement component being associated with one or more second measurement configurations specifying configurations related to the second signals,
wherein the first and second measurement configurations, as a whole, are different.

17. The node of claim 16, wherein the measurement manager is further structured to obtain the first and second measurement configurations through at least one of:
autonomously determining the measurement configuration,
determining the measurement configuration based on a pre-defined rule,
acquiring a pre-configured configuration as the measurement configuration, and
receiving the measurement configuration from another node.

18. The node of any claim 16, wherein in order to obtain the composite measurement, the measurement manager is structured to:
request the measuring node for the composite measurement, the request including at least one of the first and second measurement configurations, and
receive from the measuring node the composite measurement.

19. The node of claim 16, wherein in order to obtain the composite measurement, the measurement manager is structured to:
acquire the first and second measurement components respectively based on the first and second measurement configurations, and
combine the first and second measurements,
wherein in order to obtain the composite measure, the measurement manager is structured to:
perform measurements on the first and second physical signals/channels respectively according to the first and second measurement configurations, or
acquire from the measuring node the first and second measurement components, the request including at least one of the first and second measurement configurations.

20. The node of claim 16, wherein the measurement manager is structured to:
obtain configuration differences between the first measurement configurations and the second measurement configurations, and
determine the position of the target wireless device based on the configuration differences in addition to the composite measurement.

21. The node of claim 16,
wherein each of the first and second measurement configurations is of one configuration type among a plurality of configuration types,
wherein the configuration types include a resource configuration type characterizing configurations of resources used to transmit one or more signal(s) of interest for positioning, a signal configuration type characterizing configurations of the one or more signal(s) of interest, a transmitter configuration type characterizing configurations of a transmitting node transmitting the one or more signal(s) of interest, and a receiver configuration type characterizing configurations of a receiving node receiving the one or more signal(s) of interest,
wherein the first measurement configurations comprise any one or more of a first resource configuration of the resource configuration type, a first signal configuration of the signal configuration type, a first transmitter configuration of the transmitter configuration type, and a first receiver configuration of the receiver configuration type,
wherein the second measurement configuration comprise any one or more of a second resource configuration of the resource configuration type, a second signal configuration of the signal configuration type, a second transmitter configuration of the transmitter configuration type, and a second receiver configuration of the receiver configuration type, and
wherein the first and second measurement configurations includes at least one configuration type in common, in which the configurations of the common configuration type are different.

22. The node of claim 21,
wherein each resource configuration type of the resource configuration type comprises configurations of one or both of time and frequency resources,
wherein each signal configuration of the signal configuration type comprises configurations of any one or more of one or more physical signals in uplink and/or downlink, one or more physical channels in uplink and/or downlink, and one or more logical channels in uplink and/or downlink,
wherein each transmitter configuration of the transmitter configuration type as applied to transmission of signals/channels of interest comprises any one or more of, transmit antenna configuration, transmit beam configuration, transmit power level, and transmitter attenuation, and
wherein each receiver configuration of the receiver configuration type as applied to reception of signals/channels of interest comprises any one or more of receive antenna configuration, receive beam configuration, and receiver attenuation.

23. The node of claim 19,
wherein in order to combine the first and second measurement components, the measurement manager is structured to apply a combining function that combines the first and second measurement components to arrive at the composite measure, and
wherein the combining function is in the form of μ_{composite}=f(μ₁, μ₂, . . . , μᵢ, . . . ; w₁, w₂, . . . , wᵢ, . . . ) in which μ_{composite} represents the composite measurement, μᵢ represent individual measurement components including μ₁ and μ₂ respectively representing first and second measurement components, and wᵢ represent corresponding weights including w₁ and W₂ respectively representing first and second weights.

24. The node of claim 19,
wherein the first measurement component comprises any one or more of a first received signal power, a first received signal quality, a first total received power, a first total received noise, a first angle-of-arrival, a first timing, and a first channel profile of one or more first radio channels, and
wherein the second measurement component comprises any one or more of a second received signal power, a second received signal quality, a second total received power, a second total received noise, a second angle-of-arrival, a second timing, and a second channel profile of one or more second radio channels.

25. A radio node structured to assist in positioning of a target wireless device, the radio node comprising:
a communicator structured to receive a positioning information request from a requesting node, the positioning information request being related to positioning of the target wireless device,
a measurement manager structured to:
obtain one or more first measurement configurations and one or more second measurement configurations based on the positioning information request, the first measurement configurations specifying configurations related to one or more first signals transmitted from a transmitting node, and the second measurement configurations specifying configurations related to one or more second signals one transmitted from the same transmitting node, and
measure the first signals and the second signals corresponding to the first and second measurement configurations, and
a positioning data manager structured to:
obtain a positioning information response based on measurement results, and
send the positioning information response to the requesting node,
wherein the positioning information response comprises any combination of a first measurement component, a second measurement component, a composite measurement, and a positioning result,
wherein the first measurement component includes measurements performed on the first signals/channels transmitted from the transmitting node and measured by the radio node, the first measurement component being associated with the first measurement configurations,
wherein the second measurement component includes measurements performed on one or more second signals/channels transmitted from the transmitting node and measured by the radio node, the second measurement component being associated with the second measurement configurations,
wherein the first and second measurement configurations, as a whole, are different,
wherein the composite measurement is based on at least the first and second measurement components, and
wherein the positioning result indicates positioning of the target wireless device.

26. The radio node of claim 25,
wherein each of the first and second measurement configurations is of one configuration type among a plurality of configuration types,
wherein the configuration types include a resource configuration type characterizing configurations of resources used to transmit one or more signal(s) of interest for positioning, a signal configuration type characterizing configurations of the one or more signal(s) of interest, a transmitter configuration type characterizing configurations of a transmitting node transmitting the one or more signal(s) of interest, and a receiver configuration type characterizing configurations of a receiving node receiving the one or more signal(s) of interest,
wherein the first measurement configurations comprise any one or more of a first resource configuration of the resource configuration type, a first signal configuration of the signal configuration type, a first transmitter configuration of the transmitter configuration type, and a first receiver configuration of the receiver configuration type,
wherein the second measurement configuration comprise any one or more of a second resource configuration of the resource configuration type, a second signal configuration of the signal configuration type, a second transmitter configuration of the transmitter configuration type, and a second receiver configuration of the receiver configuration type, and
wherein the first and second measurement configurations includes at least one configuration type in common, in which the configurations of the common configuration type are different.

27. The radio node of claim 25, wherein in order to obtain the positioning information response comprises, the positioning data manager is structured to:
include the first measurement component and/or the second measurement in the positioning information response,
combine the first and second measurement components to obtain the composite measurement, and include the composite measurement in the positioning information response, and/or
obtain the positioning result at least based on the composite measurement, and include the positioning result in the positioning information response.

28. A network node structured to assist in positioning of a target wireless device, the network node comprising:
a communicator structured to receive a positioning information request from a requesting node, the positioning information request being related to positioning of a target wireless device,
a measurement manager structured to:
obtain one or more first measurement configurations and one or more second measurement configurations based on the positioning information request, the first measurement configurations specifying configurations related to one or more first signals transmitted from a transmitting node and measured by a measuring node, and the second measurement configurations specifying configurations related to one or more second signals one transmitted from the same transmitting node and measured by the same measuring node,
send a measurement request to the measuring node requesting measurements of the first and second signals corresponding to the first and second measurement configurations, and
receive a measurement report from the measuring node, and a positioning data manager structured to:
obtain a positioning information response based on the measurement report, and
send the positioning information response to the requesting node,
wherein the measurement report comprises any combination of a first measurement component, a second measurement component, and a composite measurement,
wherein the positioning information response comprises any combination of the first measurement component, the second measurement component, the composite measurement, and the positioning result,
wherein the first measurement component includes measurements performed on the first signals/channels transmitted from the transmitting node and measured by the measuring node, the first measurement component being associated with the first measurement configurations,
wherein the second measurement component includes measurements performed on one or more second signals/channels transmitted from the transmitting node and measured by the measuring node, the second measurement component being associated with the second measurement configurations,
wherein the first and second measurement configurations, as a whole, are different,
wherein the composite measurement is based on at least the first and second measurement components, and
wherein the positioning result indicates positioning of the target wireless device.

29. The network node of claim 28,
wherein each of the first and second measurement configurations is of one configuration type among a plurality of configuration types,
wherein the configuration types include a resource configuration type characterizing configurations of resources used to transmit one or more signal(s) of interest for positioning, a signal configuration type characterizing configurations of the one or more signal(s) of interest, a transmitter configuration type characterizing configurations of a transmitting node transmitting the one or more signal(s) of interest, and a receiver configuration type characterizing configurations of a receiving node receiving the one or more signal(s) of interest,
wherein the first measurement configurations comprise any one or more of a first resource configuration of the resource configuration type, a first signal configuration of the signal configuration type, a first transmitter configuration of the transmitter configuration type, and a first receiver configuration of the receiver configuration type,
wherein the second measurement configuration comprise any one or more of a second resource configuration of the resource configuration type, a second signal configuration of the signal configuration type, a second transmitter configuration of the transmitter configuration type, and a second receiver configuration of the receiver configuration type, and
wherein the first and second measurement configurations includes at least one configuration type in common, in which the configurations of the common configuration type are different.

30. The network node of claim 28, wherein in order to obtain the positioning information response comprises, the positioning data manager is structured to:
include the first measurement component and/or the second measurement from the measurement report into the positioning information response,
include the composite measurement from the measurement report into the positioning information response,
combine the first and second measurement components from the measurement report to obtain the composite measurement, and include the combining result as the composite measurement into the positioning information response, and/or
obtain the positioning result at least based on the composite measurement, and include the positioning result in the positioning information response.
